(19) United States
(12) Patent Application Publication
(10) Pub. No.: US 2023/0161225 A1
(43) Pub. Date: May 25, 2023

(54) CAMERA ACTUATOR AND CAMERA MODULE INCLUDING SAME

(71) Applicant: LG INNOTEK CO., LTD., Seoul (KR)

(72) Inventors: Chang Hyuck LEE, Seoul (KR); Kyung Won KIM, Seoul (KR)

(21) Appl. No.: 17/917,611

(22) PCT Filed: Apr. 8, 2021
(86) PCT No.: PCT/KR2021/004449

§ 371 Date: Oct. 7, 2022

(30) Foreign Application Priority Data
Apr. 10, 2020 (KR) 10-2020-0043891

(51) Int. Cl. G03B 5/00

(52) U.S. Cl. CPC G03B 5/00; G03B 13/36; G03B 2205/003; G03B 2205/0061

(57) ABSTRACT

A camera actuator according to an embodiment includes a housing; a prism unit disposed in the housing; and a first driving unit for tilting the prism unit; wherein the prism unit includes: the prism; and a prism mover disposed to surround the prism, and a second driving unit disposed between the prism and the prism mover and tilting the prism, and wherein a driving displacement of the second driving unit is smaller than a driving displacement of the first driving unit.

### TECHNICAL FIELD

An embodiment relates to a camera actuator and a camera module.

### BACKGROUND ART

A camera module captures a subject and stores it as an image or video, and is installed in various devices such as mobile terminals such as cell phones, laptops, drones, and vehicles.

In general, the device described above is equipped with a miniature camera module, and the camera module can perform an autofocus (AF) function of automatically adjusting the distance between the image sensor and the lens to align the focal lengths of the lenses. In addition, the camera module may perform a zooming function of zooming up or zooming out by increasing or decreasing the magnification of a distant subject through a zoom lens.

Meanwhile, a zoom actuator is used for a zooming function in the camera module. However, friction torque is generated when the lens is moved due to the mechanical movement of the actuator, and problems such as a decrease in driving force, an increase in power consumption, and a decrease in control characteristics occur due to the friction torque.

In particular, in order to derive the optical properties, not only alignment between a plurality of lens groups but also alignment of a plurality of lens groups with the image sensor must be well matched. However, when the center of the spherical surface between the lens groups deviates from the optical axis, tilt, which is a lens inclination phenomenon, or a phenomenon that the central axis of the lens group and the image sensor is not aligned, there is a problem in that the image quality or resolution is deteriorated because the angle of view is changed or the focus is out of focus.

In addition, when increasing the separation distance in a region where friction is generated to reduce friction torque resistance when moving the lens for the zoom function in the camera module, there is a technical problem in that a lens decent or a lens tilt is deepened when the zoom movement or the zoom movement is reversed.

In addition, recent camera modules employ image stabilization (IS) technology to correct or prevent image stabilization due to camera movement caused by an unstable fixing device or a user’s movement.

Such image stabilization (IS) technology includes an optical image stabilizer (OIS) technology and an image stabilization prevention technology using an image sensor. Here, OIS technology is a technology that corrects motion by changing the path of light, and the image stabilization prevention technology using the image sensor is a technology that compensates for motion in both mechanical and electronic ways, and recently, OIS technology is being adopted more and more.

Meanwhile, the camera module may include a reflective member, a driving unit, etc. that can change the path of light to implement the OIS function. The reflective member may be tilted by a driving force applied from the driving unit, and a path of light may be changed during this process. For example, when the camera module detects a hand-shake vibration waveform generated by a user, the reflective member may tilt to compensate for the hand-shake vibration waveform. However, there is a problem in that a relatively small vibration waveform is generated or a deviation occurs between the hand-shake vibration waveform caused by problems such as noise and sync of components and a waveform compensating for the vibration waveform. However, when a relatively small vibration waveform occurs or problems such as noise and sync of components occur, there is a problem in that there is a deviation between the hand-shake vibration waveform caused by such a problem and the waveform that compensates for it. In this case, the optical characteristics of the camera module may be deteriorated, and there is a problem that the effect of the OIS function is insignificant.

Therefore, a new camera module capable of solving the above problems is required.

### DISCLOSURE

### Technical Problem

An embodiment provides a camera actuator and a camera module having improved optical properties.

In addition, the embodiment provides a camera actuator and a camera module that can effectively control the vibration generated by hand shake.

In addition, the embodiment provides a camera actuator and a camera module having improved autofocus and high magnification zoom functions.

In addition, the embodiment provides a camera actuator and a camera module capable of preventing problems such as de-centering, tilting, friction, etc. occurring when the lens group is moved.

### Technical Solution

A camera actuator according to an embodiment may include a housing; a prism unit disposed in the housing; and a first driving unit for tilting the prism unit; wherein the prism unit includes: the prism; and a prism mover disposed to surround the prism, and a second driving unit disposed between the prism and the prism mover and tilting the prism, and wherein a driving displacement of the second driving unit may be is smaller than a driving displacement of the first driving unit.

In addition, the second driving unit includes a plurality of piezoelectric devices, wherein the prism mover includes an inner surface facing one side surface of the prism and inclined at a predetermined angle, and wherein the plurality of piezoelectric devices may be is disposed on the inner surface of the prism mover.

In addition, the first driving unit includes a plurality of sub driving units including a coil unit and a magnet, wherein the plurality of sub driving units includes: a first sub driving unit facing a first outer surface of the prism mover; a second sub driving unit facing a second outer surface of the prism mover; and a third sub driving unit facing a lower surface of the prism mover, wherein the first and second sub driving units face each other in a first direction, and wherein the third sub driving unit may face the prism unit in a second direction perpendicular to the first direction.

In addition, the first driving unit may be provided to rotate the prism unit in the second direction with a virtual first line formed by the first and second sub driving units in the first direction as an axis.

In addition, the first driving unit may be provided to rotate the prism unit in the first direction with a virtual second line formed by the third and fourth sub driving units in the second direction as an axis.

In addition, the plurality of piezoelectric devices may include first and second piezoelectric devices spaced apart from each other in the second direction; and third and fourth piezoelectric devices spaced apart from each other in the first direction.

In addition, the prism may be provided to be rotationally movable in the second direction by at least one of the first and second piezoelectric devices on the prism mover.

In addition, the prism may be provided to be rotatably movable in the first direction by at least one of the third and fourth piezoelectric devices on the prism mover.

In addition, the second driving unit includes: a circuit board disposed on the inner surface of the prism mover; and a base layer disposed on the circuit board and including a plurality of openings, and wherein the plurality of piezoelectric devices may be respectively disposed in the plurality of openings.

In addition, the base layer may include an elastically deformable material.

In addition, a thickness of the plurality of piezoelectric devices may be greater than or equal to a thickness of the base layer.

In addition, the camera module according to the embodiment includes a first camera actuator and a second camera actuator, wherein the first camera actuator performs an auto focusing or zoom function, the second camera actuator performs an OIS (Optical Image Stabilizer) function, and wherein the first camera actuator may include the camera actuator.

In addition, light incident on the camera module from an outside may be incident on the first camera actuator through the second camera actuator.

### Advantageous Effects

The camera actuator and the camera module according to the embodiment may effectively control vibration caused by hand shake. In detail, the embodiment may include a first driving unit capable of tilting the prism unit to a first axis or a second axis. In addition, the embodiment further includes a second driving unit for driving with a driving displacement smaller than that of the first driving unit, wherein the second driving unit can tilt the prism disposed on the prism unit to a first axis or a second axis. In this case, the second driving unit may be driven by a driving displacement corresponding to a deviation occurring between the hand-shake vibration and the driving of the first driving unit. That is, the second driving unit can be driven as much as the driving displacement corresponding to the deviation caused by noise and sync of the first driving unit, and accordingly, it is possible to effectively control vibrations caused by hand shake, and thus have improved optical properties.

In addition, the camera actuator and the camera module according to the embodiment may have improved optical properties. In detail, in the camera actuator and camera module according to the embodiment, the driving unit for moving the lens group includes a piezoelectric device, and the driving unit can more precisely control the lens group. In addition, the camera actuator and the camera module according to the embodiment may minimize friction generated when the lens group is moved. Accordingly, the embodiment may provide more improved autofocus and zoom functions.

### DESCRIPTION OF DRAWINGS

FIG. 1 is a perspective view of a camera module according to an embodiment.

FIG. 2 is a perspective view in which some components are omitted from the camera module according to the embodiment.

FIG. 3 is an exploded perspective view of a first camera actuator according to an embodiment.

FIG. 4 is a view of a first driving unit of a first camera actuator according to an embodiment.

FIG. 5 is a view of a first housing of a first camera actuator according to an embodiment.

FIGS. 6 and 7 are views of a prism unit of a first camera actuator according to an embodiment.

FIG. 8 is an exemplary view illustrating an operation of a first driving unit in a first camera actuator according to an embodiment.

FIGS. 9 to 11 are views of a second driving unit of the first camera actuator according to an embodiment.

FIG. 12 is an exemplary view illustrating an operation of a second driving unit in a first camera actuator according to an embodiment.

FIG. 13 is a graph of OIS implementation according to first and second driving units in the first camera actuator according to the embodiment.

FIG. 14 is an exploded perspective view of a second camera actuator according to an embodiment.

FIG. 15 is a cross-sectional view of a second camera actuator according to an embodiment.

FIG. 16 is a front view of a second camera actuator according to an embodiment.

FIG. 17 is a perspective view illustrating third and fourth driving units disposed in a housing of a second camera actuator according to an embodiment.

FIG. 18 is an exploded perspective view of a third driving unit according to an embodiment.

FIG. 19 is an exploded perspective view of a fourth driving unit according to an embodiment.

FIG. 20 is a perspective view of a partial configuration of a second camera actuator according to an embodiment.

FIG. 21 is a perspective view of a mobile terminal to which a camera module according to an embodiment is applied.

FIG. 22 is a perspective view of a vehicle to which a camera module according to an embodiment is applied.

### MODES OF THE INVENTION

Hereinafter, embodiments of the present invention will be described in detail with reference to the accompanying drawings.

However, the spirit and scope of the present invention is not limited to a part of the embodiments described, and may be implemented in various other forms, and within the spirit and scope of the present invention, one or more of the elements of the embodiments may be selectively combined and substituted for use.

In addition, unless expressly otherwise defined and described, the terms used in the embodiments of the present invention (including technical and scientific terms may be construed the same meaning as commonly understood by one of ordinary skill in the art to which this invention belongs, and the terms such as those defined in commonly used dictionaries may be interpreted as having a meaning that is consistent with their meaning in the context of the relevant art.

Further, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements. In addition, when an element is described as being “connected”, “coupled”, or “connected” to another element, it may include not only when the element is directly “connected” to, “coupled” to, or “connected” to other elements, but also when the element is “connected”, “coupled”, or “connected” by another element between the element and other elements.

In addition, when described as being formed or disposed “on (over)” or “under (below)” of each element, the “on (over)” or “under (below)” may include not only when two elements are directly connected to each other, but also when one or more other elements are formed or disposed between two elements. Further, when expressed as “on (over)” or “under (below)”, it may include not only the upper direction but also the lower direction based on one element.

An optical axis direction used below may be defined as an optical axis direction of a lens coupled to a camera actuator and a camera module, and a vertical direction may be defined as a direction perpendicular to the optical axis.

A autofocus function used below may be defined a function to automatically focus on the subject by adjusting the distance from the image sensor by moving the lens in the optical axis direction according to the distance of the subject so that a clear image of the subject can be obtained by the image sensor.

Meanwhile, the auto focus may correspond to auto focus (AF). In addition, closed-loop auto focus (CLAF) control may be defined as real-time feedback control of the lens position by sensing the distance between the image sensor and the lens to improve focus adjustment accuracy.

In addition, before the description of the embodiment of the invention, a first direction may mean a x-axis direction shown in the drawings, a second direction may be a different direction from the first direction. For example, the second direction may mean a y-axis direction shown in the drawing in a direction perpendicular to the first direction. Also, a third direction may be different from the first and second directions. For example, the third direction may mean a z-axis direction shown in the drawing in a direction perpendicular to the first and second directions. Here, the third direction may mean an optical axis direction.

Hereinafter, the configuration of the camera module according to the present embodiment will be described with reference to the drawings.

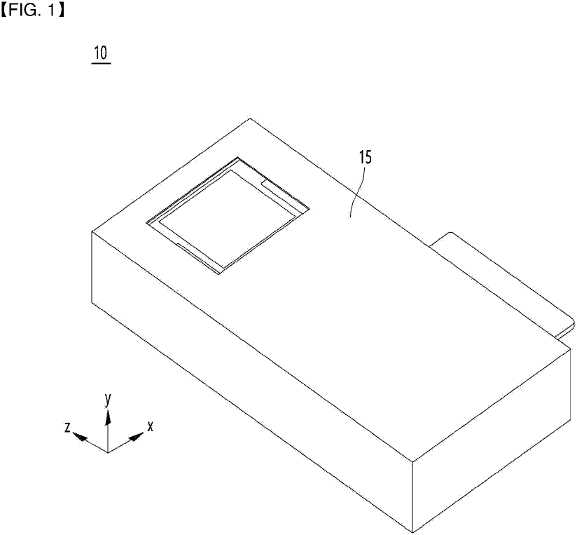

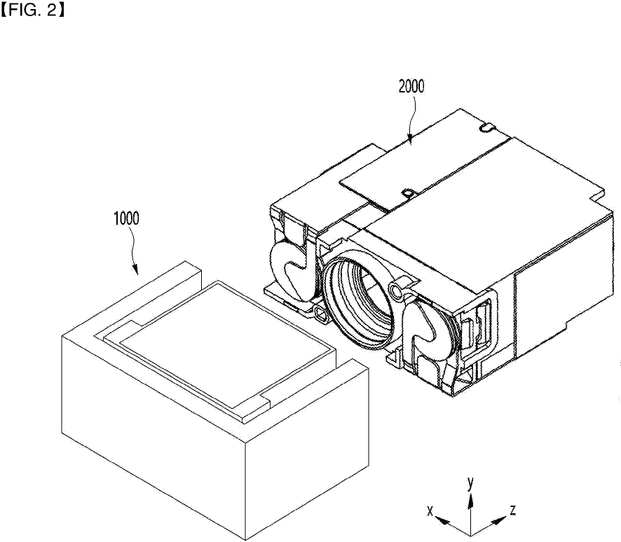

FIG. 1 is a perspective view of a camera module according to an embodiment, and FIG. 2 is a perspective view in which some components are omitted from the camera module according to the embodiment.

Referring to FIGS. 1 and 2, the camera module 10 according to the embodiment may include one or a plurality of camera actuators. For example, the camera module 10 may include a first camera actuator 1000 and a second camera actuator 2000, and a cover case 15 for protecting the first camera actuator 1000 and the second camera actuator 2000 may be included.

The first camera actuator 1000 may be an optical image stabilizer (OIS) actuator. In this case, the light incident on the camera module 10 from the outside may be preferentially incident on the first camera actuator 1000. In addition, the light incident on the first camera actuator 1000 may be incident on the second camera actuator 2000 by changing the path of the light, and the light passing through the second camera actuator 2000 may be incident on the image sensor 2900.

The second camera actuator 2000 may be a zoom and/or auto focus actuator. The second camera actuator 2000 may include a plurality of lenses. The second camera actuator 2000 may perform a zoom or autofocus function by moving at least one lens in the optical axis direction according to a control signal of a controller.

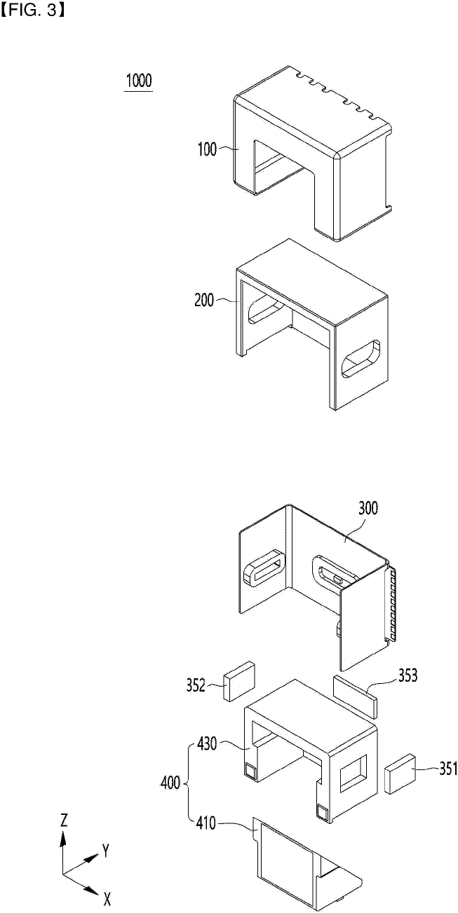

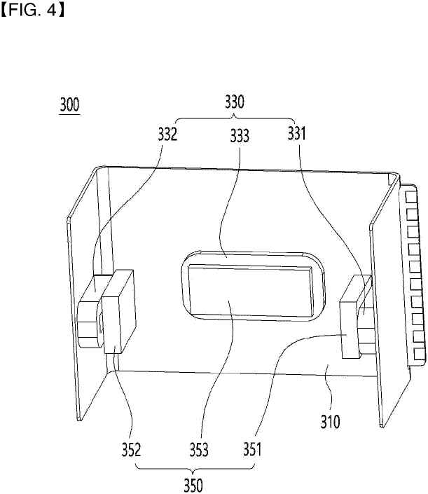

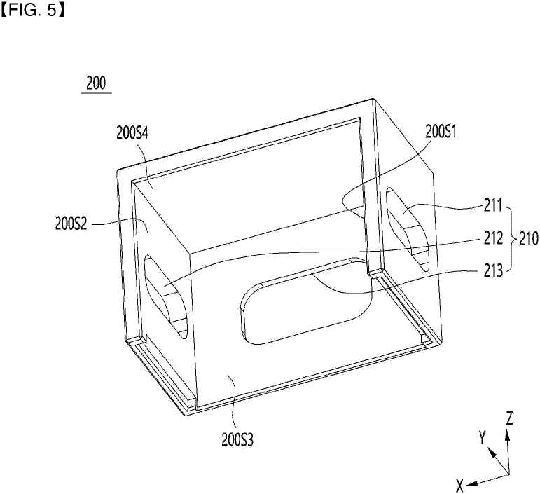

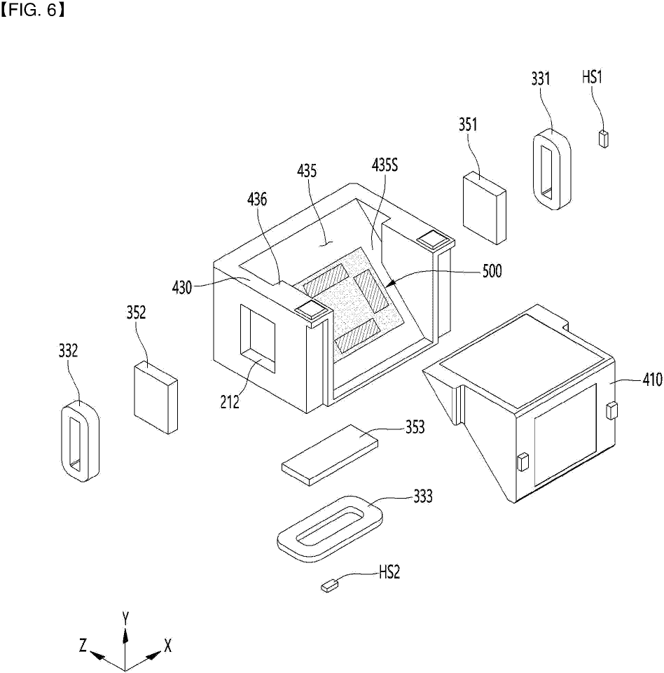

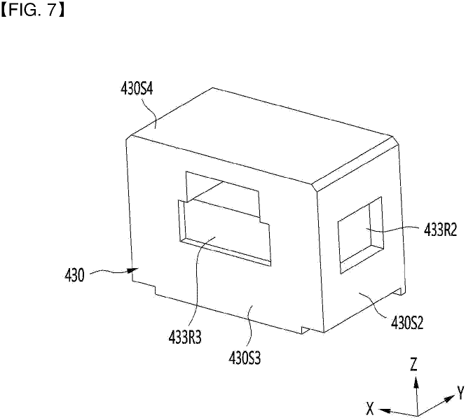

FIG. 3 is an exploded perspective view of a first camera actuator according to an embodiment, and FIG. 4 is a view of a first driving unit of a first camera actuator according to an embodiment. In addition, FIG. 5 is a view of a first housing of a first camera actuator according to an embodiment, and FIGS. 6 and 7 are views of a prism unit of a first camera actuator according to an embodiment.

The first camera actuator 1000 according to the embodiment will be described in more detail with reference to FIGS. 3 to 7.

Referring to FIG. 3, the first camera actuator 1000 may include a cover member 100, a first housing 200, a first driving unit 300, a prism unit 400, and a second driving unit 500.

The cover member 100 may include an accommodating space therein, and at least one side surface may be open. For example, the cover member 100 may have a structure in which a plurality of side surfaces connected to each other are opened. In detail, the cover member 100 may have a structure in which a front surface through which light is incident from the outside, a lower surface corresponding to the first camera actuator 1000, and a rear surface opposite the front surface, and a light movement path of the prism unit 400, which will be described later, may be provided.

The cover member 100 may include a rigid material. For example, the cover member 100 may include a material such as resin, metal, or ceramic, and may support the third housing 200 disposed in the accommodation space. For example, the cover member 100 is disposed to surround the first housing 200, the third driving unit 300, the prism unit 400, and the like, and may support the components.

Referring to FIG. 4, the first driving unit 300 may include a first circuit board 310, a coil unit 330, and a magnet 350.

The first circuit board 310 may be connected to a power source (not shown) to apply power to the coil unit 330. The first circuit board 310 may include a circuit board having a wiring pattern that can be electrically connected, such as a rigid printed circuit board (Rigid PCB), a flexible printed circuit board (Flexible PCB), and a rigid flexible printed circuit board (Rigid Flexible PCB).

The coil unit 330 may be electrically connected to the first circuit board 310. The coil unit 330 may include one or a plurality of coil units. For example, the coil unit 330 may include a first coil unit 331, a second coil unit 332, and a third coil unit 333.

The first to third coil units 331, 332, and 333 may be spaced apart from each other. For example, the first circuit board 310 may have a ‘C’ shape, and the first coil unit 331 and the second coil unit 332 may be respectively disposed on first and second surfaces of the first circuit board 310 facing each other. Also, the third coil unit 333 may be disposed on a third surface connecting the first and second surfaces of the first circuit board 310.

The magnet 350 may include one or a plurality of magnets. For example, the magnet 350 may include a first magnet 351, a second magnet 352, and a third magnet 353 disposed in a region corresponding to the coil unit 330. In detail, the first magnet 351 may be disposed on the first surface of the first circuit board 310. In detail, the first magnet 351 may be disposed on a region corresponding to the first coil unit 331. Also, the second magnet 352 may be disposed on the second surface of the first circuit board 310. The second magnet 352 may be disposed on a region corresponding to the second coil unit 332. Also, the third magnet 353 may be disposed on the third surface of the first circuit board 310. The third magnet 353 may be disposed on a region corresponding to the third coil unit 333.

The first driving unit 300 may further include a sensing unit. For example, the first driving unit 300 may further include a Hall sensor and a gyro sensor (not shown). The Hall sensor may include a first Hall sensor HS1 disposed adjacent to one coil unit selected from among the first coil unit 331 and the second coil unit 332. The first Hall sensor HS1 may detect a position of the first magnet 351. In addition, the Hall sensor may include a second Hall sensor HS2 disposed adjacent to the third coil unit 333. The second Hall sensor HS2 may detect a position of the third magnet 353.

The first driving unit 300 may tilt the prism unit 400. In detail, the first driving unit 300 may control the tilting of the prism unit 400 along a first axis or a second axis by applied power.

Referring to FIG. 5, the first housing 200 may include an accommodation space for accommodating the prism unit 400. The first housing 200 may include a plurality of inner surfaces. For example, the first housing 200 may have a first inner surface 200S1 corresponding to the first surface of the first circuit board 310, a second inner surface 200S2 corresponding to the second surface of the first circuit board 310, and a third inner surface 200S3 corresponding to the third surface of the first circuit board 310.

In detail, the first housing 200 may include a first inner surface 200S1 corresponding to the first coil unit 331 and a second inner surface 200S2 corresponding to the second coil unit 332. The first inner surface 200S1 and the second inner surface 200S2 may be disposed to face each other in a first direction (x-axis direction).

In addition, the first housing 200 may further include a third inner surface 200S3 and a fourth inner surface 200S4. The third inner surface 200S3 may be disposed in a region corresponding to the third coil unit 333. The third inner surface 200S3 may be disposed between the first inner surface 200S1 and the second inner surface 200S2 to connect the two inner surfaces. The third inner surface 200S3 may have a shape extending in the first direction (x-axis direction). The fourth inner surface 200S4 may be disposed between the first inner surface 200S1 and the second inner surface 200S2 and may be connected to the third inner surface 200S3. The fourth inner surface 200S4 may have a shape extending in the second direction (y-axis direction).

The first housing 200 may include a plurality of housing holes 210. The housing hole 210 may be a through hole penetrating outer and inner surfaces of the first housing 200. The plurality of housing holes 210 may include a first housing hole 211, a second housing hole 212, and a third housing hole 213. The first housing hole 211 may be a through hole passing through an outer surface corresponding to the first inner surface 200S1. The second housing hole 212 may be a through hole passing through an outer surface corresponding to the second inner surface 200S2. The third housing hole 213 may be a through hole passing through an outer surface corresponding to the third inner surface 200S3.

The first housing hole 211 may be disposed in a region corresponding to the first coil unit 331. Also, the first housing hole 211 may have a size and shape corresponding to that of the first coil unit 331. Accordingly, the first coil unit 331 may be disposed by being partially or entirely inserted into the first housing hole 211.

The second housing hole 212 may be disposed in a region corresponding to the second coil unit 332. Also, the second housing hole 212 may have a size and shape corresponding to that of the second coil unit 332. Accordingly, the second coil unit 332 may be disposed by being partially or entirely inserted into the second housing hole 212.

The third housing hole 213 may be disposed in a region corresponding to the third coil unit 333. Also, the third housing hole 213 may have a size and shape corresponding to that of the third coil unit 333. Accordingly, the third coil unit 333 may be disposed by being partially or entirely inserted into the third housing hole 213.

FIGS. 6 and 7, the prism unit 400 may be disposed in the first housing 200. In detail, the prism unit 400 may be disposed in the accommodation space of the first housing 200.

The prism unit 400 may include a prism 410 and a prism mover 430 disposed on the prism 410.

The prism 410 may be a right-angle prism. The prism 410 may reflect the direction of light incident from the outside. That is, the prism 410 may change the path of the light incident to the first camera actuator 1000 from the outside toward the first camera actuator 1000.

The prism mover 430 may be disposed on the prism 410. The prism mover 430 may be disposed to surround the prism 410. At least one side of the prism mover 430 may be open and may include an accommodating space therein. In detail, the prism mover 430 may have a structure in which a plurality of outer surfaces connected to each other are opened. For example, the prism mover 430 may have a structure in which an outer surface corresponding to the prism 410 is open, and may include an accommodation space defined as a first space 435 therein. The first space 435 may have a shape corresponding to the prism 410. The first space 435 may have a larger volume than the prism 410. Accordingly, the first space 435 may provide a space in which the prism 410 can be tilted.

The prism mover 430 may include an inner surface 435S. The inner surface 2435S may be an inner surface constituting the first space 2435. The inner surface 435S may be a surface facing one side surface of the prism 410. The inner surface 435S may be spaced apart from the one side surface of the prism 410. For example, when the tilting control of the prism 410 is not controlled by the second driving unit 500, the one side surface of the prism 410 may be spaced apart from the inner side 435S.

The prism mover 430 may include a step 436. The step 436 may be disposed in the first space 435. The step 436 may serve as a guide and/or a seating part for the prism 410. For example, a protrusion corresponding to the step 436 may be formed on an outside of the prism 410. Accordingly, when the prism 410 is disposed on the prism mover 430, the protrusion of the prism 410 may be guided by the step 436 of the prism mover 430 to be disposed in the first space 435. That is, the prism mover 430 may arrange the prism 410 at a position set by the step 436 and effectively support the prism 410.

In addition, the prism mover 430 may perform a stopper function of the prism 410. For example, the prism 410 may be provided to be tiltable in the first and/or second axis directions on the prism mover 430 by a second driving unit 500 to be described later. In this case, the step 436 and the inner surface 435S of the prism unit 400 may provide a stopper function when controlling the tilting of the prism 410.

For example, when the prism 410 is tilted along the first axis on the prism unit 400, the inner surface 435S may prevent the prism 410 from tilting more than a threshold. In addition, when the prism 410 is tilted along the second axis on the prism unit 400, the step 436 may prevent the prism from tilting more than a threshold. Accordingly, the prism 410 may have improved alignment characteristics and optical characteristics on the prism mover 430, and may have improved reliability.

The prism unit 400 may include a plurality of outer surfaces. For example, the prism mover 430 may include a plurality of outer surfaces. The prism mover 430 may include a first outer surface 430S1 corresponding to the first inner surface 200S1 of the first housing 200, a second outer surface 430S2 corresponding to the second inner surface 200S2, a third outer surface 430S3 corresponding to the third inner surface 200S3, and a fourth outer surface 430S4 corresponding to the fourth inner surface 200S4. Here, the third outer surface 430S3 may be a lower surface of the prism mover 430.

Also, the prism mover 430 may include a plurality of recesses. The recess may be a groove having a concave shape on the outer surface of the prism mover 430 in the direction of the first space 435. The plurality of recesses may include a first recess 433R1, a second recess 433R2, and a third recess 433R3. For example, the first recess 433R1 may be disposed on the first outer surface 430S1. The first recess 433R1 may be disposed in a region corresponding to the first housing hole 211. Also, the second recess 433R2 may be disposed on the second outer surface 430S2. The second recess 433R2 may be disposed in a region corresponding to the second housing hole 212. Also, the third recess 433R3 may be disposed on the third outer surface 430S3. The third recess 433R3 may be disposed in a region corresponding to the third housing hole 213. That is, the first housing hole 211 may correspond to the first coil unit 331, and the second housing hole 212 may correspond to the second coil unit 332. Also, the third housing hole 213 may correspond to the third coil unit 333.

The magnet 350 may be disposed in the recess. For example, the first magnet 351 is in the first recess 433R1, the second magnet 352 is in the second recess 433R2, and the third magnet 353 is in the first recess 433R1, and the magnets may be spaced apart from each other.

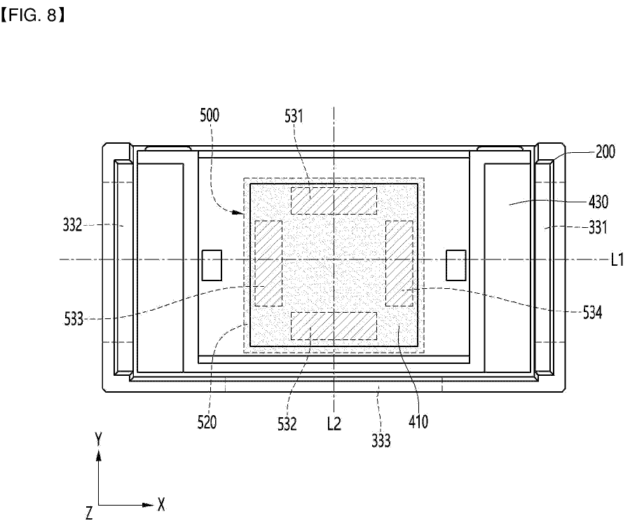

FIG. 8 is an exemplary view illustrating an operation of a first driving unit in a first camera actuator according to an embodiment.

Referring to FIG. 8, the prism unit 400 may be tilted to a first axis or a second axis by the first driving unit 300. Here, the first axis tilting may mean tilting in an up-down direction (y-axis direction; second direction) with the x-axis direction shown in the drawing as a rotation axis, and the second axis tilting may mean tilting in a left-right direction (x-axis direction; first direction) with the y-axis direction shown in the drawing as the rotation axis.

The first driving unit 300 may include a plurality of sub driving units including the coil unit 330 and the magnet 350. For example, the first driving unit 300 includes a first sub driving unit including the first coil unit 331 and the first magnet 351, a second sub driving unit including the second coil unit 332 and the second magnet 352, and a third sub driving unit including the third coil unit 333 and the third magnet 353. The first sub driving unit may be disposed to face the first outer surface 430S1, the second sub driving unit may be disposed to face the second outer surface 430S2, and the third sub driving unit may be disposed to face the third outer surface 430S3. The first sub driving unit may be disposed to face the second sub-driving unit in a first direction (x-axis direction). The third sub driving unit may be disposed to face the prism unit 400 in the second direction (y-axis direction).

The prism unit 400 may be tilted along a first axis. In detail, the first driving unit 300 may be provided such that the prism unit 400 can be rotated about a first virtual line L1 formed by the first magnet 351, the first coil unit 331, the second magnet 352, and the second coil unit 332 as an axis. Here, the first line L1 may be a line extending in the first direction (x-axis direction). The first line L1 may overlap the center of the prism 410 in the first direction.

That is, the third sub driving unit may rotate and move the prism unit 400 in an up-down direction (y-axis direction) with the first line L1 as an axis.

For example, a repulsive force may be generated between the third coil unit 333 and a third-first magnet of the third magnet 353, and an attractive force may be generated between the third coil unit 333 and a third-second magnet of the third magnet 353. Here, the third-first magnet and the third-second magnet may face each other in a third direction (z-axis direction). In this case, the prism unit 400 may be tilted in an upper direction (refer to FIG. 8) by the generated electromagnetic force.

In addition, an attractive force may be generated between the third coil unit 333 and the third-first magnet of the third magnet 353, and a repulsive force may be generated between the third coil unit 333 and the third-second magnet of the third magnet 353. In this case, the prism unit 400 may be tilted in a downward direction (refer to FIG. 8) by the generated electromagnetic force.

The prism unit 400 may be tilted along the second axis. In detail, the first driving unit 300 may be provided such that the prism unit 400 can be rotated about the second virtual line L2 formed by the third magnet 353 and the third coil unit 333 as an axis. Here, the second line L2 may be a line extending in the second direction (y-axis direction). The second line L2 of the prism 410 may overlap the center of the prism 410 in the second direction.

That is, the first and second sub driving units may rotate and move the prism unit 400 in a left-right direction (x-axis direction) about the second line L2 as an axis.

For example, a repulsive force may be generated between the first coil unit 331 and a first-first magnet of the first magnet 351, and an attractive force may be generated between the first coil unit 331 and a first-second magnet of the first magnet 351. In addition, an attractive force may be generated between the second coil unit 332 and a second-first magnet of the second magnet 352, and a repulsive force may be generated between the second coil unit 332 and a second-second magnet of the second magnet 352. Here, the first-first magnet and the second-first magnet may face each other in a first direction, and the first-second magnet and the second-second magnet may face each other in a first direction. In this case, the prism unit 400 may be tilted in the left direction (refer to FIG. 8) by the generated electromagnetic force.

In addition, an attractive force may be generated between the first coil unit 331 and the first-first magnet of the first magnet 351, and a repulsive force may be generated between the first coil unit 331 and the first-second magnet of the first magnet 351. In addition, a repulsive force may be generated between the second coil unit 332 and the second-first magnet of the second magnet 352, and an attractive force may be generated between the second coil unit 332 and the second-second magnet of the second magnet 352. In this case, the prism unit 400 may be tilted in the right direction (refer to FIG. 8) by the generated electromagnetic force.

That is, the first camera actuator 1000 according to the embodiment includes a VCM (Voice Coil Motor) type first driving unit 300, and an optical image stabilizer (OIS) may be implemented by controlling the movement path of the incident light to the first axis and/or the second axis by the first driving unit 300. In this case, the first camera actuator 1000 may have improved optical properties by minimizing the occurrence of a decent and a tilt phenomenon when implementing OIS. However, the embodiment is not limited thereto, and the first driving unit 300 may include a piezoelectric device, for example, a piezo-electric device or a shape memory alloy. In this case, the first driving unit 300 may tilt the prism unit 400 using a physical change of a piezoelectric device or a shape memory alloy, and may control a movement path of the incident light.

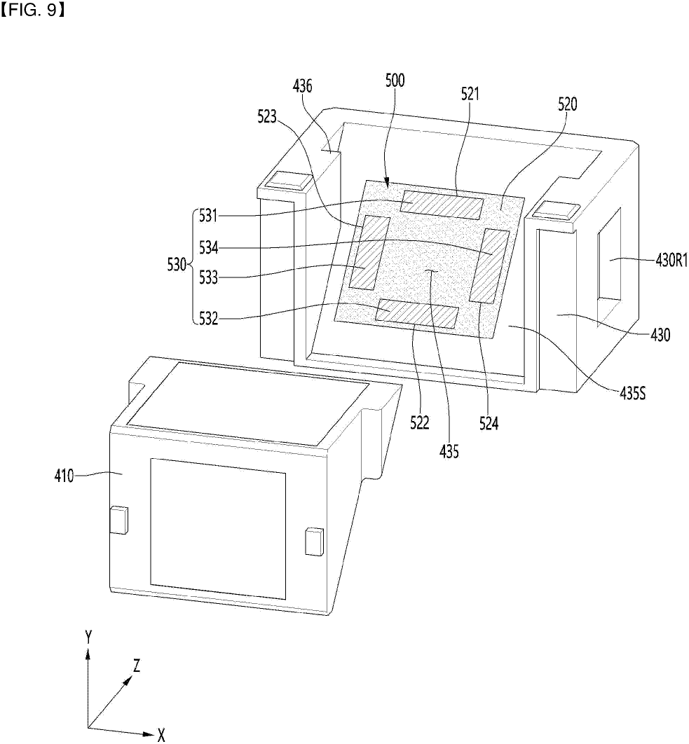

FIGS. 9 to 11 are views of a second driving unit of the first camera actuator according to an embodiment.

Referring to FIGS. 9 to 11, the first camera actuator 1000 according to the embodiment may include a second driving unit 500. The second driving unit 500 may be disposed on the prism unit 400. For example, the second driving unit 500 may be disposed on the prism mover 430. The second driving unit 500 may be disposed between the prism 410 and the prism mover 430. In detail, the second driving unit 500 may be disposed on an inner surface 435S of the prism mover 430. That is, the second driving unit 500 may be disposed to face one side surface of the prism 410 on the inner surface 435S inclined at a predetermined angle. The inclination angle of the inner surface 435S may correspond to an inclination angle of one side surface of the prism 410.

The second driving unit 500 may include a second circuit board 510, a base layer 520, and a piezoelectric device 530.

The second circuit board 510 may be disposed on the inner surface 435S of the prism mover 430. A plan area of the second circuit board 510 may be smaller than a plan area of the inner surface 435S. Power may be applied to the plurality of piezoelectric devices 530. The second circuit board 510 may include a circuit board having a wiring pattern that can be electrically connected, such as a rigid printed circuit board (Rigid PCB), a flexible printed circuit board (Flexible PCB), and a rigid flexible printed circuit board (Rigid Flexible PCB).

The base layer 520 may be disposed on the inner surface 435S of the prism mover 430. The base layer 520 may be disposed on the second circuit board 510. The base layer 520 may be disposed in direct contact with an upper surface of the second circuit board 510. The base layer 520 may have a predetermined thickness and may include a soft and elastic material. For example, the base layer 520 may include at least one of silicones, thermoplastic resins, thermoplastic silicone resins, thermoplastic elastomers, polyurethane elastomers, ethylene vinyl acetate (EVA), harmless plasticizers, and polyvinyl chloride (PVC) material with added stabilizer. The base layer 520 may be elastically deformed by the prism 410. For example, the prism 410 may be tilted by a piezoelectric device 530 to be described later. In this process, the prism 410 may press a partial region of the base layer 520, and the partial region of the base layer 520 may be elastically deformed by the pressure. In addition, when a driving force is removed from the prism 410 to return to an original position, the partial region of the base layer 520 may be elastically restored.

The base layer 520 may include an opening. The opening may be a through hole penetrating upper and lower surfaces of the base layer 520. Here, the upper surface of the base layer 520 may be a surface facing one side surface of the prism 410, and the lower surface of the base layer 520 may be a surface facing the second circuit board 510. The opening may expose an upper surface of the second circuit board 510.

A plurality of the openings may be disposed on the base layer 520. In detail, a number of openings may correspond to a number of piezoelectric devices 530 to be described later. The plurality of openings may be spaced apart from each other. For example, the plurality of openings may include a first opening 521 and a second opening 522 spaced apart from each other in the second direction. Also, the plurality of openings may include a third opening 523 and a fourth opening 524 spaced apart from each other in the first direction. The third opening 523 and the fourth opening 524 may be disposed in a region between the first opening 521 and the second opening 522.

The piezoelectric device 530 may be disposed on the inner surface 435S of the prism mover 430. The piezoelectric device 530 may be disposed on the second circuit board 510. The piezoelectric device 530 may be electrically connected to the second circuit board 510. In addition, the piezoelectric device 530 may be disposed in direct or indirect contact with the prism 410. For example, the prism 410 may be physically coupled through an adhesive member (not shown) disposed between the upper surface of the piezoelectric device 530 and one side surface of the prism 410.

The piezoelectric device 530 may include a material that causes mechanical deformation by applied power. The piezoelectric device 530 may include a piezo-electric device. The piezoelectric device 530 may include a ceramic material. For example, the piezoelectric device 530 may include at least one of ZnO, AlN, LiNbO4, lead antimony stannate, lead magnesium tantalate, lead nickel tantalate, titanates, tungstates, zirconates, or lead zirconate titanates [Pb(ZrxTi1-x)O3(PZT)], lead lanthanum zirconate titanate (PLZT), lead niobium zirconate titanate (PNZT), BaTiO3, SrTiO3, lead magnesium niobate, lead nickel niobate, lead manganese niobate, lead zinc niobate, lead, barium and bismuth, including lead titanate, and niobates of strontium.

A plurality of piezoelectric devices 530 may be disposed on the second circuit board 510. The plurality of piezoelectric devices 530 may be respectively disposed in the opening of the base layer 520. For example, the plurality of piezoelectric devices 530 may include a first piezoelectric device 531, a second piezoelectric device 532, a third piezoelectric device 533, and a fourth piezoelectric device 534 spaced apart from each other. The first piezoelectric device 531 may be disposed in the first opening 521 of the base layer 520. Also, the second piezoelectric device 532 may be disposed in the second opening 522 of the base layer 520. Also, the third piezoelectric device 533 may be disposed in the third opening 523 of the base layer 520. Also, the fourth piezoelectric device 534 may be disposed in the fourth opening 524 of the base layer 520.

That is, the first piezoelectric device 531 and the second piezoelectric device 532 may be disposed to be spaced apart from each other in the second direction. Also, the third piezoelectric device 533 and the fourth piezoelectric device 534 may be disposed to be spaced apart from each other in the first direction. The third piezoelectric device 533 and the fourth piezoelectric device 534 may be disposed in a region between the first piezoelectric device 531 and the second piezoelectric device 532.

The first piezoelectric device 531 may have the same shape and height as the second piezoelectric device 532. In addition, the third piezoelectric device 533 may have the same shape and height as the fourth piezoelectric device 534. Also, the first to fourth piezoelectric devices 531, 532, 533, and 534 may have the same height.

The first to fourth piezoelectric devices 531, 532, 533, and 534 may have a planar shape corresponding to each of the first to fourth openings 521, 522, 523, and 524. In addition, the first to fourth piezoelectric devices 531, 532, 533, and 534 may have a width corresponding to each of the first to fourth openings 521, 522, 523, and 524.

In addition, the first to fourth piezoelectric devices 531, 532, 533, and 534 may have a thickness greater than or equal to a depth of each of the first to fourth openings 521, 522, 523 and 524. That is, the first to fourth piezoelectric devices 531, 532, 533, and 534 may be thicker than the base layer 520 or have the same thickness as the base layer 520.

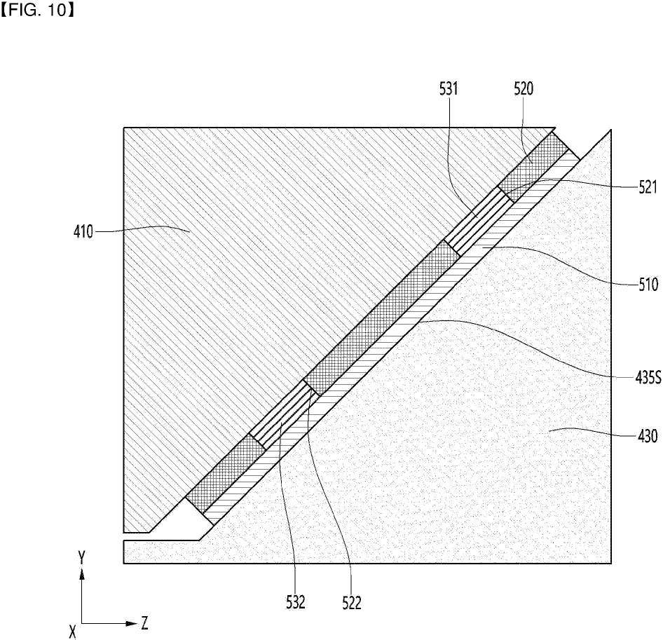

For example, when the thickness of the first to fourth piezoelectric devices 531, 532, 533, and 534 is the same as the depth of the first to fourth openings 521, 522, 523 and 524, the upper surfaces of the first to fourth piezoelectric devices 531, 532, 533, and 534 may be disposed on the same plane as the upper surface of the base layer 520 as shown in FIG. 10. Accordingly, when no driving force is applied to the prism 410, the upper surface of the base layer 520 and the piezoelectric device 530 may be disposed in contact with one side surface of the prism 410.

In addition, when the thickness of the first to fourth piezoelectric devices 531, 532, 533, and 534 is greater than the depth of the first to fourth openings 521, 522, 523 and 524, the upper surfaces of the first to fourth piezoelectric devices 531, 532, 533, and 534 may be disposed above the upper surface of the base layer 520. Accordingly, when no driving force is applied to the prism 410, the piezoelectric device 530 may be disposed in contact with one side surface of the prism 410 and may be spaced apart from the upper surface of the base layer 520 by a predetermined distance.

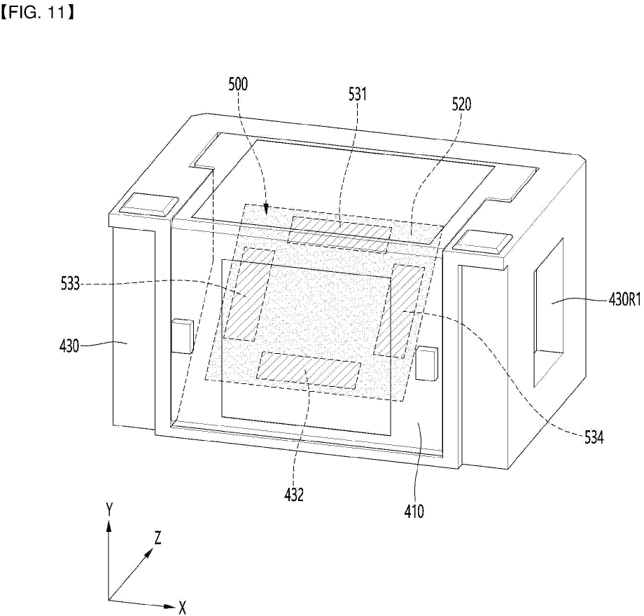

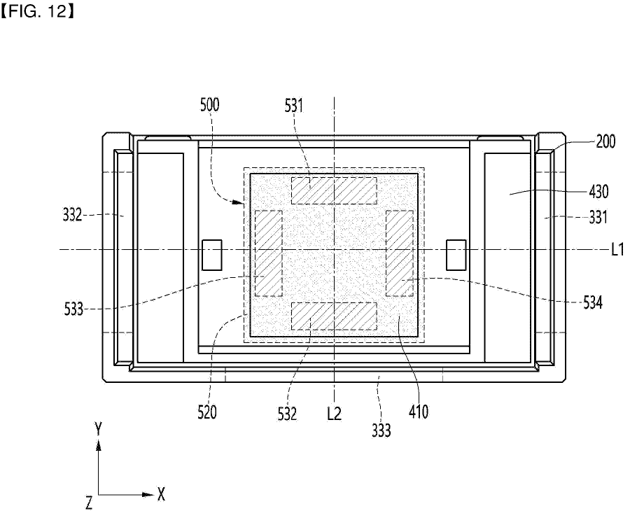

FIG. 12 is an exemplary view illustrating an operation of a second driving unit in a first camera actuator according to an embodiment.

Referring to FIG. 12, the piezoelectric device 530 may be mechanically deformed by applied power. In detail, the piezoelectric device 530 may expand or contract when a set power is applied. For example, the piezoelectric device 530 may expand toward one side surface of the prism 410 or contract in an opposite direction. The piezoelectric device 530 may expand or contract in the optical axis direction.

In this process, the piezoelectric device 530 of the second driving unit 500 may tilt the prism 410. In detail, the piezoelectric device 530 may control the tilting of the prism 410 in a first axis or a second axis by an applied power.

For example, the prism 410 may be tilted along the first axis on the prism mover 430. The prism 410 may be rotated in an up-down direction (refer to FIG. 12) with the first line L1 as an axis by the piezoelectric device 530. The prism 410 may be rotated in an up-down direction (y-axis direction) by at least one of the first piezoelectric device 531 and the second piezoelectric device 532.

In detail, the first piezoelectric device 531 may expand by applied power. In addition, the second piezoelectric device 532 may be contracted by an applied power or maintain a set shape because no power is applied. Accordingly, the prism 410 may be tilted in a downward direction (refer to FIG. 12) about the first line L1 as an axis by mechanical deformation of the piezoelectric device 530. Here, since power is not applied to the third piezoelectric device 533 and the fourth piezoelectric device 534, deformation may not occur. Alternatively, the third piezoelectric device 533 and the fourth piezoelectric device 534 may be deformed by a predetermined power to provide a driving force for tilting the prism 410 in a downward direction.

Also, the second piezoelectric device 532 may expand by applied power. In addition, the first piezoelectric device 531 may be contracted by an applied power or maintain a set shape because no power is applied. Accordingly, the prism 410 may be tilted in an upward direction (refer to FIG. 12) about the first line L1 as an axis by mechanical deformation of the piezoelectric device 530. Here, since power is not applied to the third piezoelectric device 533 and the fourth piezoelectric device 534, deformation may not occur. Alternatively, the third piezoelectric device 533 and the fourth piezoelectric device 534 may be deformed by a predetermined power to provide a driving force for tilting the prism 410 in an upward direction.

The prism 410 may be tilted along the second axis on the prism mover 430. The prism 410 may be rotated and moved in a left-right direction (refer to FIG. 12) with the second line L2 as an axis by the piezoelectric device 530. The prism 410 may be rotated in a left-right direction (x-axis direction) by at least one of the third piezoelectric device 533 and the fourth piezoelectric device 534.

In detail, the third piezoelectric device 533 may expand by applied power. In addition, the fourth piezoelectric device 534 may be contracted by an applied power or maintain a set shape because no power is applied. Accordingly, the prism 410 may be tilted in the right direction (refer to FIG. 12) about the second line L2 as an axis by mechanical deformation of the piezoelectric device 530. Here, since no power is applied to the first piezoelectric device 531 and the second piezoelectric device 532, deformation may not occur. Alternatively, the first piezoelectric device 531 and the second piezoelectric device 532 may be deformed by a predetermined power to provide a driving force for tilting the prism 410 in the right direction.

Also, the fourth piezoelectric device 534 may expand by applied power. In addition, the third piezoelectric device 533 may be contracted by an applied power or maintain a set shape because no power is applied. Accordingly, the prism 410 may be tilted in a left direction (refer to FIG. 12) about the second line L2 as an axis by mechanical deformation of the piezoelectric device 530. Here, since no power is applied to the first piezoelectric device 531 and the second piezoelectric device 532, deformation may not occur. Alternatively, the first piezoelectric device 531 and the second piezoelectric device 532 may be deformed by a predetermined power to provide a driving force for tilting the prism 410 in the left direction.

That is, the first camera actuator 1000 according to the embodiment includes the second driving unit 500, and the prism 410 may be tilted to a first axis or a second axis by the second driving unit 500. Accordingly, the second driving unit 500 may minimize the deviation generated when the OIS is implemented by the first driving unit 300.

In this case, a driving displacement of the second driving unit 500 may be smaller than a driving displacement of the first driving unit 300. For example, the driving displacement of the second driving unit 500 may be about 30% or less of the driving displacement of the first driving unit 300.

In detail, when the driving displacement of the second driving unit 500 exceeds about 30% of the driving displacement of the first driving unit 300, the tilting angle of the prism 410 may be relatively large. That is, the range in which the prism 410 changes on the prism mover 430 is relatively large, so that the required size of the prism mover 430 may increase. In addition, when the driving displacement of the second driving unit 500 exceeds about 30% of the driving displacement of the first driving unit 300, the coupling force between the prism 410 and the prism mover 430 may be reduced. Accordingly, the driving displacement of the second driving unit 500 preferably satisfies the above-described range.

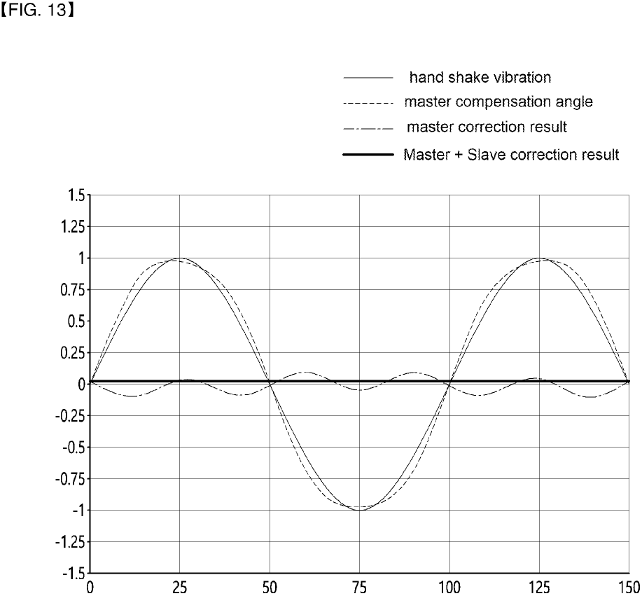

FIG. 13 is a graph of OIS implementation according to first and second driving units in the first camera actuator according to the embodiment. In detail, FIG. 13 is a graph of hand-shake vibration and waveforms of the first driving unit and the second driving unit.

The first camera actuator 1000 may effectively compensate for hand-shake vibration generated by the first driving unit 300 and the second driving unit 500.

For example, as shown in FIG. 13, when a waveform is generated due to hand shake vibration, the first driving unit 300 may form a compensation waveform (master compensation angle in FIG. 13) corresponding to the hand shake vibration waveform. However, as shown in FIG. 13, a deviation may occur between the hand-shake vibration waveform and the compensation waveform of the first driving unit 300. For example, deviation due to noise of the first driving unit 300, for example, noise of the coil unit 330, noise of the hall sensors HS1 and HS2, noise of the gyro sensor, driving sync of components, etc. may occur.

In this case, the second driving unit 500 may form a correction waveform (the master correction result of FIG. 13) corresponding to the deviation. Here, the correction waveform may be a waveform for a difference between the hand-shake vibration waveform and the compensation waveform of the first driving unit 300. That is, the second driving unit 500 may change with a smaller driving displacement than the first driving unit 300 in order to compensate for the minutely generated waveform. Accordingly, the first camera actuator 1000 may obtain a waveform according to the correction result waveform (the Master + Slave correction result of FIG. 13).

That is, in the embodiment, the hand-shake vibration may be more effectively corrected by the second driving unit 500 driven by a driving displacement corresponding to a deviation between the hand-shake vibration and the first driving unit 300. Accordingly, the first camera actuator 1000 may have improved optical characteristics when implementing OIS.

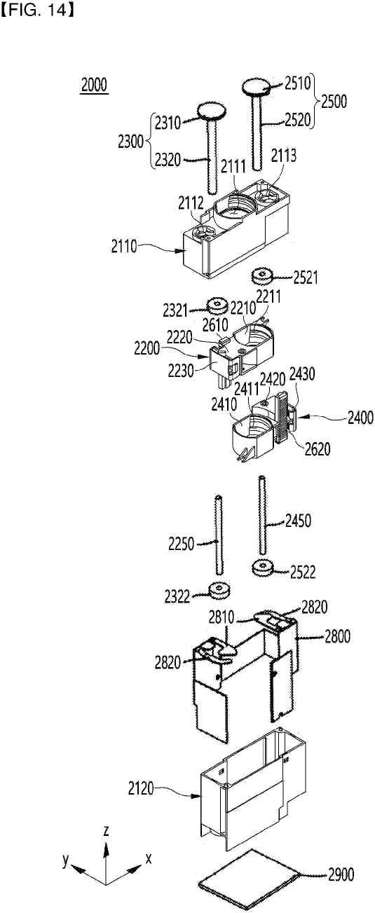

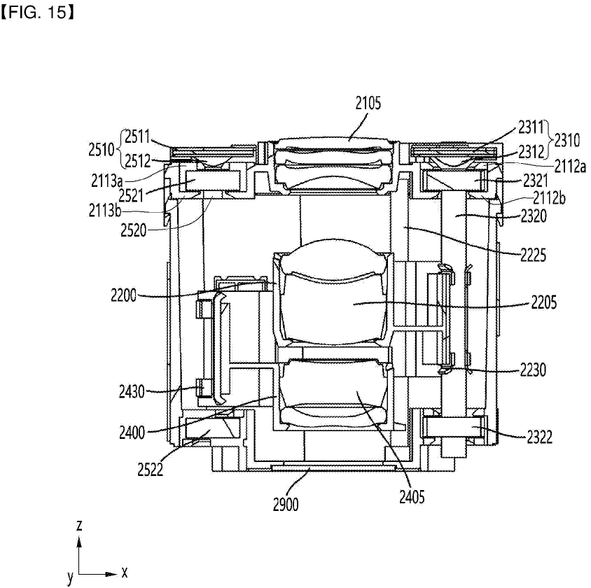

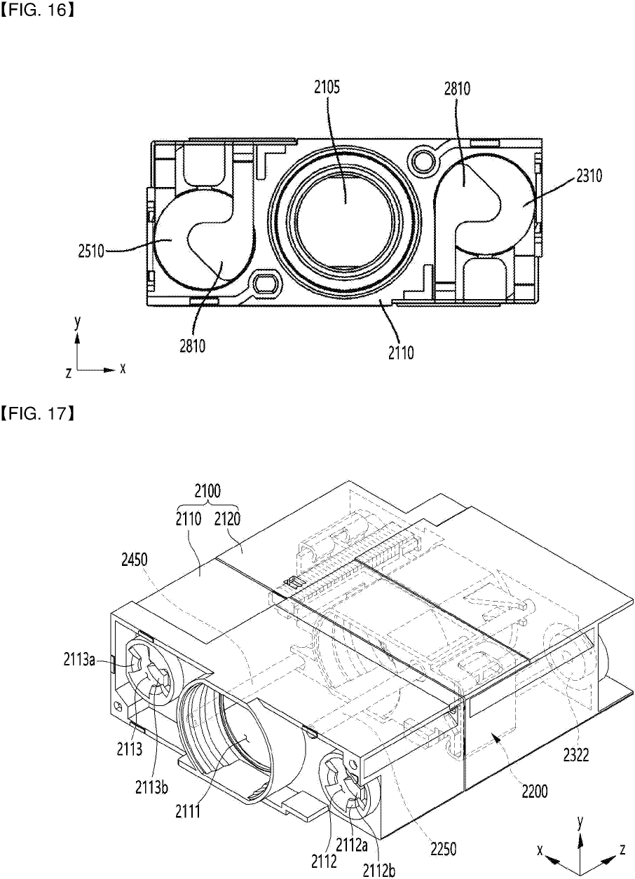

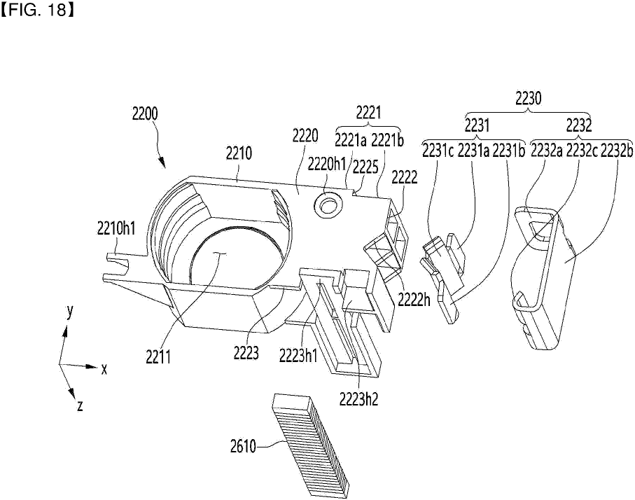

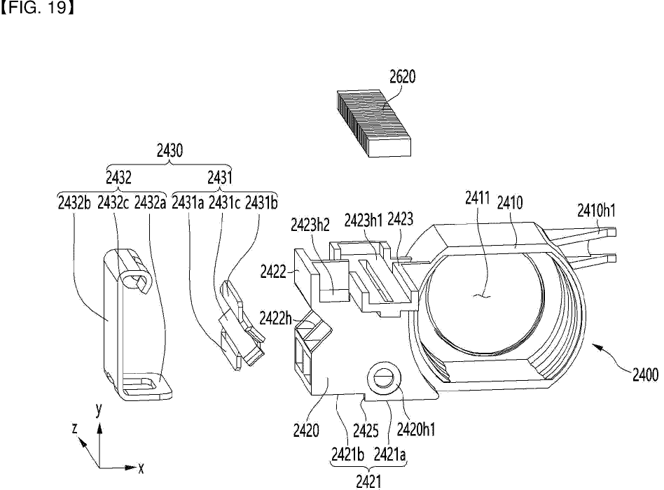

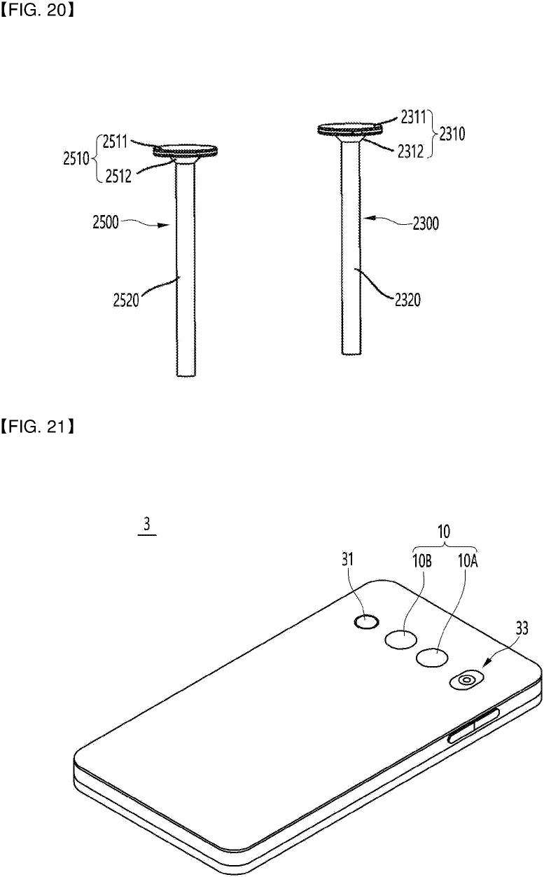

FIG. 14 is an exploded perspective view of a second camera actuator according to an embodiment, and FIG. 15 is a cross-sectional view of a second camera actuator according to an embodiment. In addition, FIG. 16 is a front view of a second camera actuator according to an embodiment, and FIG. 17 is a perspective view illustrating third and fourth driving units disposed in a housing of a second camera actuator according to an embodiment. In addition, FIGS. 18 and 19 are exploded perspective views of first and second driving units according to the embodiment, and FIG. 20 is a perspective view of a partial configuration of a second camera actuator according to an embodiment.

Referring to FIGS. 14 to 20, the second camera actuator 2000 according to the embodiment may include a second housing 2100, a first lens unit 2105, a first lens barrel 2200, a third driving unit 2300, a second lens barrel 2400, and a fourth driving unit 2500.

The second housing 2100 may form an exterior of the second camera actuator 2000. The second housing 2100 may have upper and lower partial regions open and may have a hexahedral shape.

The second housing 2100 may include an accommodating space therein. The first lens barrel 2200, the third driving unit 2300, the second lens barrel 2400, and the fourth driving unit 2500 may be accommodated in the accommodating space of the second housing 2100.

The second housing 2100 may include a first sub-housing 2110 and a second sub-housing 2120.

The first sub-housing 2110 may include a first hole 2111. The first hole 2111 may be formed on one side of the first sub-housing 2110. The first hole 2111 is a hollow hole and may be a hole passing through outside and inside of the first sub-housing 2110.

The first sub-housing 2110 may further include a second hole 2112 and a third hole 2113. The second hole 2112 and the third hole 2113 may be disposed on one side of the first sub-housing 2110. The second hole 2112 and the third hole 2113 may be hollow holes passing through the outside and the inside of the first sub-housing 2110. The second hole 2112 and the third hole 2113 may be spaced apart from the first hole 2111. In detail, the first hole 2111 may be disposed between the second hole 2112 and the third hole 2113. The first hole 2111 may be disposed at equal intervals to the second hole 2112 and the third hole 2113.

The second hole 2112 may include a plurality of protrusions protruding from an inner circumferential surface of the second hole 2112 toward the center of the second hole 2112. For example, the plurality of protrusions may include a first protrusion 2112a disposed at an upper end of the second hole 2112 and a second protrusion 2112b disposed at a lower end of the second hole 2112 in the optical axis direction.

In detail, the first protrusion 2112a may include a plurality of first sub-protrusions (not shown) spaced apart from each other. The plurality of first sub-protrusions may be arranged at equal intervals from the center of the second hole 2112 along a circumference of a concentric circle shape. Also, the second protrusion 2112b may be spaced apart from the first protrusion 2112a in the optical axis direction. The second protrusion 2112b may be disposed below the first protrusion 2112a. The second protrusion 2112b may include a plurality of second sub-protrusions (not shown) spaced apart from each other. The plurality of second sub-protrusions may be arranged at equal intervals from the center of the second hole 2112 along a circumference of a concentric circle shape. The first protrusion 2112a and the second protrusion 2112b may provide a space in which a portion of the third driving unit 2300 to be described later, for example, the first buffer member 2321 is disposed.

The third hole 2113 may include a plurality of protrusions protruding from an inner circumferential surface of the third hole 2113 toward the center of the third hole 2113. The plurality of protrusions may include a third protrusion 2113a disposed at an upper end of the third hole 2113 and a fourth protrusion 2113b disposed at a lower end of the second hole 2112 with respect to the optical axis direction.

The third protrusion 2113a may include a plurality of third sub-protrusions (not shown) spaced apart from each other. The plurality of third sub-protrusions may be arranged at equal intervals from the center of the third hole 2113 along a circumference of a concentric circle shape. Also, the fourth protrusion 2113b may be spaced apart from the third protrusion 2113a in the optical axis direction. The fourth protrusion 2113b may include a plurality of fourth sub-protrusions (not shown) spaced apart from each other. The plurality of fourth sub-protrusions may be arranged at equal intervals from the center of the third hole 2113 along a circumference of a concentric circle shape. The third protrusion 2113a and the fourth protrusion 2113b may provide a space in which a portion of the fourth driving unit 2500 to be described later, for example, a third buffer member 2521 is disposed.

The second sub-housing 2120 may be disposed under the first sub-housing 2110. In detail, the second sub-housing 2120 may be disposed under the first sub-housing 2110 in a third direction (z-axis, optical-axis direction). The second sub-housing 2120 may be disposed closer to an image sensor 2900 to be described later than the first sub-housing 2110. The first lens barrel 2200, the third driving unit 2300, the second lens barrel 2400, and the fourth driving unit 2500 may be disposed in the second sub-housing 2120.

The second sub-housing 2120 may be coupled to the first sub-housing 2110. For example, the first sub-housing 2110 and the second sub-housing 2120 may be coupled by a separate fastening member (not shown) such as a screw. In addition, the first sub-housing 2110 and the second sub-housing 2120 may be coupled to each other by physical coupling of coupling jaws and coupling grooves respectively formed therein.

The first lens unit 2105 may be disposed in the second housing 2100 and may include at least one lens. For example, the first lens unit 2105 may be disposed in the first sub-housing 2110. In detail, the first lens unit 2105 may be disposed in the first hole 2111 of the first sub-housing 2110. For example, the first lens unit 2105 may be coupled to the first sub-housing 2110 by a screw thread formed on an inner circumferential surface of the first hole 2111.

The first lens barrel 2200 may be disposed in the second housing 2100. The first lens barrel 2200 may be disposed in the second sub-housing 2120. The first lens barrel 2200 may be disposed under the first lens unit 2105. For example, the first lens barrel 2200 may be disposed below the first lens unit 2105 in the optical axis direction, and may be closer to the image sensor 2900 than the first lens unit 2105. The first lens barrel 2200 may be coupled to the third driving unit 2300. The first lens barrel 2200 may move in the second housing 2100 by the third driving unit 2300. In detail, the first lens barrel 2200 may be moved in the optical axis direction by the third driving unit 2300.

The first lens barrel 2200 may include a first barrel part 2210, a second lens unit 2205, a first guide part 2220, and a first elastic part 2230.

The first barrel part 2210 may be disposed in a region overlapping the optical axis and may have an open shape on one surface and the other surface. For example, the first barrel part 2210 may have a cylindrical shape in which one surface and the other surface are open.

The first barrel part 2210 may include the first through hole 2211. The first through hole 2211 may be a through hole penetrating through one surface and the other surface of the first barrel part 2210. Here, one surface of the first barrel part 2210 may be a surface facing the first lens unit 2105, and the other surface may be a surface opposite to the one surface and facing the image sensor 2900.

The second lens unit 2205 may be disposed on the first barrel part 2210. In detail, the second lens unit 2205 may be disposed in the first through hole 2211. For example, a screw line may be formed on an inner circumferential surface of the first through hole 2211, and the second lens unit 2205 may be coupled to the first barrel part 2210 by the screw line.

The second lens unit 2205 may include at least one lens. The second lens unit 2205 may perform a zoom function. The second lens unit 2205 may move in the optical axis direction. In detail, the second lens unit 2205 may move in the optical axis direction with respect to the first lens unit 2105.

The first guide part 2220 may extend outwardly from the first barrel part 2210. For example, the first guide part 2220 may extend from the first barrel part 2210 in a direction perpendicular to the optical axis, for example, in a first direction (x-axis direction).

The first guide part 2220 may include a first upper surface 2221, a first side surface 2222, and a first lower surface 2223.

The first upper surface 2221 may face an inner upper surface of the second housing 2100. The first upper surface 2221 may face the inner upper surface of the second housing 2100 in the second direction (y-axis direction). The first upper surface 2221 may include a plurality of sub upper surfaces. In detail, the first upper surface 2221 may include a first sub upper surface 2221a and a second sub upper surface 2221b that is disposed lower than the first sub upper surface 2221a in a second direction (y-axis direction). That is, the second sub upper surface 2221b may be disposed adjacent to the first lower surface 2223 than the first sub upper surface 2221a. At least one first fastening protrusion (not shown) may be disposed on the second sub upper surface 2221b. The first fastening protrusion may have a shape protruding upward on the second sub upper surface 2221b. The first fastening protrusion may be inserted into a first fixing groove (not shown) formed in a first elastic part 2230 to be described later.

Also, the first upper surface 2221 may include a first stepped surface 2225 disposed between the first sub upper surface 2221a and the second sub upper surface 2221b. The first stepped surface 2225 may be connected to ends of the first sub upper surface 2221a and the second sub upper surface 2221b. The first stepped surface 2225 may be defined as the first stepped portion 2225. That is, the first upper surface 2221 may include the first sub upper surface 2221a, the second sub upper surface 2221b, and the first stepped portion 2225, and may have a stepped structure.

The first lower surface 2223 may face an inner lower surface of the second housing 2100 to be described later. A first groove 223h1 may be disposed on the first lower surface 2223. The first groove 223h1 may have a concave shape in a direction from the first lower surface 2223 to the first upper surface 2221. A first magnetic scaler 2610, which will be described later, may be disposed in the first groove 223h1.

Also, a second groove 2223h2 may be disposed on the first lower surface 2223. The second groove 2223h2 may be spaced apart from the first groove 223h1. The second groove 2223h2 may be disposed in an edge region of the first lower surface 2223. The second groove 2223h2 may provide a region in which a portion of the first elastic part 2230, which will be described later, is disposed. In detail, the second groove 2223h2 may provide a region in which the first elastic part 2230 is mounted and fixed.

The first side surface 2222 may be disposed between the first upper surface 2221 and the first lower surface 2223. In detail, the first side surface 2222 may be a surface connecting the first upper surface 2221 and the first lower surface 2223. In more detail, the first side surface 2222 may be a surface connecting the second sub upper surface 2221b and the first lower surface 2223. The first side surface 2222 may face a second inner surface of the second sub-housing 2120 to be described later.

A first recess 2222h may be disposed on the first side surface 2222. The first recess 2222h may have a concave shape in a direction from the first side surface 2222 to the first barrel part 2210. Also, the first recess 2222h may have a groove shape extending in the optical axis direction (z-axis direction). The first recess 2222h may have a V-shape when viewed from a front.

The first guide part 2220 may include a first insertion hole 2220h1. The first insertion hole 2220h1 may be a hole passing through one surface and the other surface of the first guide part 2220. Here, one surface of the first guide part 2220 may be a surface facing the first lens unit 2105, and the other surface may be a surface opposite to the one surface and facing the image sensor 2900.

A first pin 2250 may be disposed in the first insertion hole 2220h1. The first pin 2250 may be disposed to pass through the first insertion hole 2220h1. The first pin 2250 may have a shape extending in the optical axis direction (z-axis direction), and may have a length in the optical axis direction longer than that of the first lens barrel 2200. The first pin 2250 may be coupled to at least one of the first sub-housing 2110 and the second sub-housing 2120. The first lens barrel 2200 may move the first pin 2250 as a movement axis in the optical axis direction. Through this, the second lens unit 2205 disposed in the first lens barrel 2200 may perform a zoom function and/or an autofocus function.

The first elastic part 2230 may be disposed on the first guide part 2220. For example, the first elastic part 2230 may be disposed on the first upper surface 2221, the first lower surface 2223, and the first side surface 2222 of the first guide part 2220. The first elastic part 2230 may be coupled to the first guide part 2220.

The first elastic part 2230 may include a first elastic member 2231 and a second elastic member 2232.

The first elastic member 2231 may be coupled to the first guide part 2220. The first elastic member 2231 may be disposed at a set position on the first side surface 2222.

The first elastic member 2231 may have a shape corresponding to the first side surface 2222. For example, the first elastic member 2231 may include a first region 2231a, a second region 2231b, and a third region 2231c.

The first region 2231a and the second region 2231b may be disposed on the first side surface 2222 of the first guide part 2220 and may be spaced apart from each other. The first region 2231a and the second region 2231b may be disposed on a region of the first side surface 2222 in which the first recess 2222h is not disposed.

The third region 2231c may be disposed between the first region 2231a and the second region 2231b to connect the two regions 2231a and 2231b. The third region 2231c may be disposed in a region corresponding to the first recess 2222h. The third region 2231c may have a V-shape corresponding to the first recess 2222h.

The second elastic member 2232 may be disposed on the first guide part 2220. The second elastic member 2232 may be coupled to the first guide part 2220.

The second elastic member 2232 may include a fourth region 2232a, a fifth region 2232b, and a sixth region 2232c.

The fourth region 2232a may be disposed on the first upper surface 2221 of the first guide part 2220. In detail, the fourth region 2232a may be disposed on the second sub upper surface 2221b of the first guide part 2220. The fourth region may include a first fixing groove (not shown). The first fixing groove may be disposed in a region corresponding to the first fastening protrusion, and may have a shape corresponding to the first fastening protrusion.

The fifth region 2232b may be connected to the fourth region 2232a. For example, the fifth region 2232b may be bent at one end of the fourth region 2232a and may be disposed on the first side surface 2222 of the first guide part 2220. The fifth region 2232b may be disposed on the first elastic member 2231. The fifth region 2232b may be parallel to the first region 2231a and the second region 2231b. The fifth region 2232b may be disposed to cover the first elastic member 2231.

The sixth region 2232c may be connected to the fifth region 2232b. For example, the sixth region 2232c may be bent at one end of the fifth region 2232b and may be disposed on the first lower surface 2223 of the first guide part 2220. A portion of the sixth region 2232c may be inserted into the second groove 2223h2 disposed on the first lower surface 2223.

That is, the second elastic member 2232 may be physically coupled to the first guide part 2220 by inserting the sixth region 2232c into the second groove 2223h2 while the first fixing groove formed in the fourth region 2232a engages the first fastening protrusion. Accordingly, the first elastic part 2230 may maintain a state firmly coupled to the first guide part 2220.

In addition, the first lens barrel 2200 may further include a first guide groove 2210h1. The first guide groove 2210h1 may be disposed in a region extending outwardly from the first barrel part 2210. The first guide groove 2210h1 may be disposed in a region corresponding to a second pin 2450 to be described later. The first guide groove 2210h1may provide a space into which the second pin 2450 is inserted. The first lens barrel 2200 may move in the optical axis direction by the first pin 2250 and the second pin 2450. In this case, the first guide groove 2210h1 may have an open shape at one side. For example, the first guide groove 2210h1 may have an open shape at one side facing the first inner surface of the second housing 2100. Accordingly, friction and vibration generated when the first lens barrel 2200 is moved by the third driving unit 2300 may be minimized.

The second camera actuator 2000 may include a third driving unit 2300. The third driving unit 2300 may be disposed in the second housing 2100. The third driving unit 2300 may be coupled to the first lens barrel 2200. The third driving unit 2300 may move the first lens barrel 2200 in the optical axis direction (z-axis direction).

The third driving unit 2300 may include a first piezoelectric device 2310, a first extension bar 2320, a first buffer member 2321, and a second buffer member 2322.

The first piezoelectric device 2310 may include a piezo-electric device. For example, the first piezoelectric device 2310 may include a material that causes mechanical deformation by applied power. The first piezoelectric device 2310 may contract or expand by applied power and may cause mechanical deformation in a set direction. For example, the first piezoelectric device 2310 may generate vibration while causing mechanical deformation in the optical axis direction (z-axis direction) by the applied power.

The first piezoelectric device 2310 may include a first disk part 2311 and a first protrusion 2512. The first disk part 2311 may have a plate shape and may be disposed on the second hole 2112. For example, the first disk part 2311 may be disposed on the first protrusion 2112a of the second hole 2112. In detail, the first disk part 2311 may be disposed on the plurality of first sub-protrusions. The first protrusion 2112a may support the first disk part 2311.

The first protrusion 2512 may be disposed under the first disk part 2311. In detail, the first protrusion 2512 may be disposed under the first disc part 2311 in the third direction (z-axis direction) and may be connected to the first disc part 2311. A portion of the first protrusion 2512 may be disposed in the second hole 2112. The first protrusion 2512 may have a shape protruding toward the image sensor 2900. A width (x-axis, y-axis direction) of the first protrusion 2512 may change toward the optical axis direction. For example, the width of the first protrusion 2512 may decrease as it approaches the image sensor 2900.

The first extension bar 2320 may extend in the optical axis direction. The first extension bar 2320 may be disposed parallel to the optical axis and may be connected to the first piezoelectric device 2310. For example, an upper end of the first extension bar 2320 may be connected to the first protrusion 2512. In addition, a lower end of the first extension bar 2320 may be inserted into a lower end of the second housing 2100, for example, a fourth hole (not shown) formed at the lower end of the second sub-housing 2120.

In addition, one region of the first extension bar 2320 may be connected to the first lens barrel 2200. For example, the first extension bar 2320 may be connected to the first lens barrel 2200 by the first elastic part 2230. In detail, the first extension bar 2320 may be disposed between the first elastic member 2231 and the second elastic member 2232. In more detail, the first extension bar 2320 may be disposed between the third region 2231c of the first elastic member 2231 and the fifth region 2232b of the second elastic member 2232. The first extension bar 2320 may be fixed by the elastic force of the first elastic member 2231 and the second elastic member 2232.

The first extension bar 2320 may transmit the vibration generated in the first piezoelectric device 2310 to the first lens barrel 2200. The first lens barrel 2200 may move upward or downward (z-axis direction, optical-axis direction) according to the vibration direction of the first extension bar 2320. Through this, the second lens unit 2205 in the first lens barrel 2200 may move to perform a zooming function of zooming up or zooming out.

The first buffer member 2321 may be disposed on the first extension bar 2320. The first buffer member 2321 may be disposed on an upper region of the first extension bar 2320. The first buffer member 2321 may be disposed in the second hole 2112 of the second housing 2100. For example, the first buffer member 2321 may be disposed between the first protrusion 2112a and the second protrusion 2112b of the second hole 2112. The first buffer member 2321 may be fixed to a position set by the first protrusion 2112a and the second protrusion 2112b. In addition, the first buffer member 2321 may include a through hole into which the first extension bar 2320 is inserted.

The second buffer member 2322 may be disposed on the first extension bar 2320. The second buffer member 2322 may be disposed on a lower region of the first extension bar 2320. The second buffer member 2322 may be spaced apart from the first buffer member 2321 in the optical axis direction. The second buffer member 2322 may be disposed in a fourth hole (not shown) of the second housing 2100. The second buffer member 2322 may be disposed to be inserted into the fourth hole. The second buffer member 2322 may include a through hole into which the first extension bar 2320 is inserted.

The first buffer member 2321 and the second buffer member 2322 may prevent noise caused by the vibration of the first extension bar 2320. In addition, the first buffer member 2321 and the second buffer member 2322 may prevent the first extension bar 2320 from being deformed or damaged by an external impact.

The second lens barrel 2400 may be disposed in the second housing 2100. The second lens barrel 2400 may be disposed in the second sub-housing 2120. The second lens barrel 2400 may be disposed under the first lens barrel 2200. For example, the second lens barrel 2400 may be disposed under the first lens barrel 2200 in the optical axis direction, and may be closer to the image sensor 2900 than the first lens barrel 2200. The second lens barrel 2400 may be coupled to the fourth driving unit 2500. The second lens barrel 2400 may move in the second housing 2100 by the fourth driving unit 2500. In detail, the second lens barrel 2400 may be moved in the optical axis direction by the fourth driving unit 2500.

The second lens barrel 2400 may include a second barrel part 2410, a third lens unit 2405, a second guide part 2420, and a second elastic part 2430.

The second barrel part 2410 may be disposed in a region overlapping the optical axis and may have an open shape on one surface and the other surface. For example, the second barrel part 2410 may have a cylindrical shape in which one surface and the other surface are open.

The second barrel part 2410 may include the second through hole 2411. The second through hole 2411 may be a through hole penetrating through one surface and the other surface of the second barrel part 2410. Here, one surface of the second barrel part 2410 may be a surface facing the first lens barrel 2200, and the other surface may be a surface opposite to the one surface and facing the image sensor 2900.

The third lens unit 2405 may be disposed on the second barrel part 2410. In detail, the third lens unit 2405 may be disposed in the second through hole 2411. For example, a screw line may be formed on an inner circumferential surface of the second through hole 2411, and the third lens unit 2405 may be coupled to the second barrel part 2410 by the screw line.

The third lens unit 2405 may include at least one lens. The third lens unit 2405 may perform an auto focus function. The third lens unit 2405 may move in the optical axis direction. In detail, the third lens unit 2405 may move in the optical axis direction with respect to the first lens unit 2105. The third lens unit 2405 may move separately from the second lens unit 2205. Also, the distance at which the third lens unit 2405 can move in the optical axis direction may be the same as or different from that of the second lens unit 2205.

The second guide part 2420 may extend outwardly from the second barrel part 2410. For example, the second guide part 2420 may extend from the second barrel part 2410 in a direction perpendicular to the optical axis, for example, in a first direction (x-axis direction). In this case, the second guide part 2420 may extend in a direction opposite to the first guide part 2220. For example, the first guide part 2220 may extend from the first barrel part 2210 in a +x-axis direction, and the second guide part 2420 may extend from the second barrel part 2410 in a -x-axis direction.

The second guide part 2420 may include a second lower surface 2421, a second side surface 2422, and a second upper surface 2423.

The second upper surface 2423 may face an inner upper surface of the second housing 2100. The second upper surface 2423 may face the inner upper surface of the second housing 2100 in the second direction (y-axis direction). A third groove 2423h1 may be disposed on the second upper surface 2423. The third groove 2423h1 may have a concave shape in a direction from the second upper surface 2423 to the second lower surface 2421. A second magnetic scaler 2620, which will be described later, may be disposed in the third groove 2423h1.

In addition, a fourth groove 2423h2 may be disposed on the second upper surface 2423. The fourth groove 2423h2 may be spaced apart from the third groove 2423h1. The fourth groove 2423h2 may be disposed in an edge region of the second upper surface 2423. The fourth groove 2423h2 may provide a region in which a portion of the second elastic part 2430, which will be described later, is disposed. In detail, the fourth groove 2423h2 may provide a region in which the second elastic part 2430 is mounted and fixed.

The second lower surface 2421 may face an inner lower surface of the second housing 2100. The second lower surface 2421 may face the inner lower surface of the second housing 2100 in the second direction (y-axis direction). The second lower surface 2421 may include a plurality of sub lower surfaces. In detail, the second lower surface 2421 may include a first sub lower surface 2421a and a second sub-lower surface 2421b disposed above the first sub-lower surface 2421a in a second direction (y-axis direction). That is, the second sub lower surface 2421b may be disposed closer to the second upper surface 2423 than the first sub lower surface 2421a. At least one second fastening protrusion (not shown) may be disposed on the second sub lower surface 2421b. The second fastening protrusion may have a shape protruding downward from the second sub-lower surface 2421b. The second fastening protrusion may be inserted into a second fixing groove (not shown) formed in a second elastic part 2430 to be described later.

Also, the second lower surface 2421 may include a second stepped surface 2425 disposed between the first sub lower surface 2421a and the second sub lower surface 2421b. The second stepped surface 2425 may be connected to ends of the first sub-lower surface 2421a and the second sub-lower surface 2421b. The second stepped surface 2425 may be defined as the second stepped portion 2425. That is, the second lower surface 2421 may include the first sub lower surface 2421a, the second sub lower surface 2421b, and the second stepped portion 2425 and may have a stepped structure.

The second side surface 2422 may be disposed between the second upper surface 2423 and the second lower surface 2421. In detail, the second side surface 2422 may be a surface connecting the second upper surface 2423 and the second lower surface 2421. In more detail, the second side surface 2422 may be a surface connecting the second sub-lower surface 2421b and the second upper surface 2423. The second side surface 2422 may face a first inner surface of the second sub-housing 2120 to be described later.

A second recess 2422h may be disposed on the second side surface 2422. The second recess 2422h may have a concave shape from the second side surface 2422 toward the second barrel part 2410. Also, the second recess 2422h may have a groove shape extending in the optical axis direction (z-axis direction). The second recess 2422h may have a V-shape when viewed from a front.

The second guide part 2420 may include a second insertion hole 2420h1. The second insertion hole 2420h1 may be a hole passing through one surface and the other surface of the second guide part 2420. Here, one surface of the second guide part 2420 may be a surface facing the first lens barrel 2200, and the other surface may be a surface opposite to the one surface and facing the image sensor 2900.

A second pin 2450 may be disposed in the second insertion hole 2420h1. The second pin 2450 may be disposed to pass through the second insertion hole 2420h1. The second pin 2450 may have a shape extending in the optical axis direction (z-axis direction). The second pin 2450 may be spaced apart from the first pin 2250 and may be parallel to the first pin 2250. The second pin 2450 may have a length in the optical axis direction longer than that of the second lens barrel 2400. The second pin 2450 may be coupled to at least one of the first sub-housing 2110 and the second sub-housing 2120. The second lens barrel 2400 may move the second pin 2450 as a movement axis in the optical axis direction. Through this, the third lens unit 2405 disposed in the second lens barrel 2400 may perform a zoom function and/or an autofocus function.

The second elastic part 2430 may be disposed on the second guide part 2420. For example, the second elastic part 2430 may be disposed on the second upper surface 2423, the second lower surface 2421, and the second side surface 2422 of the second guide part 2420. The second elastic part 2430 may be coupled to the second guide part 2420.

The second elastic part 2430 may include a third elastic member 2431 and a fourth elastic member 2432.

The third elastic member 2431 may be coupled to the second guide part 2420. The third elastic member 2431 may be disposed at a set position on the second side surface 2422.

The third elastic member 2431 may have a shape corresponding to the second side surface 2422. For example, the third elastic member 2431 may include a seventh region 2431a, an eighth region 2431b, and a ninth region 2431c.

The seventh region 2431a and the eighth region 2431b may be disposed on the second side surface 2422 of the second guide part 2420 and may be spaced apart from each other. The seventh region 2431a and the eighth region 2431b may be disposed on a region of the second side surface 2422 in which the second recess 2422h is not disposed.

The ninth region 2431c may be disposed between the first region 2231a and the second region 2231b to connect the two regions 2431a and 2431b. The ninth region 2431c may be disposed in a region corresponding to the second recess 2422h. The ninth region 2431c may have a V-shape corresponding to the second recess 2422h.

The fourth elastic member 2432 may be disposed on the second guide part 2420. The fourth elastic member 2432 may be coupled to the second guide part 2420.

The fourth elastic member 2432 may include a tenth region 2432a, an eleventh region 2432b, and a twelfth region 2432c.

The tenth region 2432a may be disposed on the second lower surface 2421 of the second guide part 2420. In detail, the tenth region 2432a may be disposed on the second sub lower surface 2421b of the second guide part 2420. The tenth region 2431a may include a second fixing groove (not shown). The second fixing groove may be disposed in a region corresponding to the second fastening protrusion, and may have a shape corresponding to the second fastening protrusion.

The eleventh region 2432b may be connected to the tenth region 2432a. For example, the eleventh region 2432b may be bent at one end of the tenth region 2432a and may be disposed on the second side surface 2422 of the second guide part 2420. The eleventh region 2432b may be disposed on the third elastic member 2431. The eleventh region 2432b may be parallel to the seventh region 2431a and the eighth region 2431b. The eleventh region 2432b may be disposed to cover the third elastic member 2431.

The twelfth region 2432c may be connected to the eleventh region 2432b. For example, the twelfth region 2432c may be bent at one end of the eleventh region 2432b and may be disposed on the second upper surface 2423 of the second guide part 2420. A portion of the twelfth region 2432c may be inserted into the fourth groove 2423h2 disposed on the second upper surface 2423.

That is, the fourth elastic member 243 may be be physically coupled to the second guide part 2420 by inserting the twelfth region 2432c into the fourth groove 2423h2 while the second fixing groove formed in the seventh region 2431a engages the second fastening protrusion. Accordingly, the second elastic part 2430 may maintain a state firmly coupled to the second guide part 2420.

In addition, the second lens barrel 2400 may further include a second guide groove 2410h1. The second guide groove 2410h1 may be disposed in a region extending outwardly from the second barrel part 2410. The second guide groove 2410h1 may be disposed in a region corresponding to the first pin 2250. The second guide groove 2410h1 may provide a space into which the first pin 2250 is inserted. The second lens barrel 2400 may move in the optical axis direction by the first pin 2250 and the second pin 2450. In this case, the second guide groove 2410h1 may have an open shape at one side. For example, the second guide groove 2410h1 may have an open shape at one side facing the second inner surface of the second housing 2100. Accordingly, friction and vibration generated when the second lens barrel 2400 is moved by the fourth driving unit 2500 can be minimized.

The second camera actuator 2000 may include a fourth driving unit 2500. The fourth driving unit 2500 may be disposed in the second housing 2100. The fourth driving unit 2500 may be coupled to the second lens barrel 2400. The fourth driving unit 2500 may move the second lens barrel 2400 in the optical axis direction (z-axis direction).

The fourth driving unit 2500 may include a second piezoelectric device 2510, a second extension part 2520, a third buffer member 2521, and a fourth buffer member 2522.

The second piezoelectric device 2510 may include a piezo-electric device. For example, the second piezoelectric device 2510 may include a material that causes mechanical deformation by applied power. The second piezoelectric device 2510 may contract or expand by applied power and may cause mechanical deformation in a set direction. For example, the second piezoelectric device 2510 may generate vibration while causing mechanical deformation in the optical axis direction (z-axis direction) by the applied power.

The second piezoelectric device 2510 may include a second disk part 2511 and a second protrusion 2512. The second disk part 2511 has a plate shape and may be disposed on the third hole 2113. For example, the second disk part 2511 may be disposed on the third protrusion 2113a of the third hole 2113. In detail, the second disk part 2511 may be disposed on the plurality of third sub-protrusions. The third protrusion 2113a may support the second disc part 2511.

The second protrusion 2512 may be disposed under the second disk part 2511. In detail, the second protrusion 2512 may be disposed under the second disc part 2511 in the third direction (z-axis direction) and may be connected to the second disc part 2511. A portion of the first protrusion 2512 may be disposed in the third hole 2113. The second protrusion 2512 may have a shape protruding toward the image sensor 2900. A width (x-axis, y-axis direction) of the second protrusion 2512 may change toward the optical axis direction. For example, the width of the second protrusion 2512 may decrease as it approaches the image sensor 2900.

The second extension part 2520 may extend in the optical axis direction. The second extension part 2520 may be disposed parallel to the optical axis and may be connected to the second piezoelectric device 2510. For example, an upper end of the second extension part 2520 may be connected to the second protrusion 2512. Also, the lower end of the second extension part 2520 may be inserted into the lower end of the second housing 2100, for example, a fifth hole (not shown) formed at the lower end of the second sub-housing 2120.

In addition, one region of the second extension part 2520 may be connected to the second lens barrel 2400. For example, the second extension part 2520 may be connected to the second lens barrel 2400 by the second elastic part 2430. In detail, the second extension part 2520 may be disposed between the third elastic member 2431 and the fourth elastic member 2432. In more detail, the second extension part 2520 may be disposed between the ninth region 2431c of the third elastic member 2431 and the eleventh region 2432b of the fourth elastic member 2432. The second extension part 2520 may be fixed by the elastic force of the third elastic member 2431 and the fourth elastic member 2432.

The second extension part 2520 may transmit the vibration generated in the second piezoelectric device 2510 to the second lens barrel 2400. The second lens barrel 2400 may move upward or downward (z-axis direction, optical-axis direction) according to the vibration direction of the second extension part 2520. Through this, the third lens unit 2405 in the second lens barrel 2400 may move to perform a zooming function of zooming up or zooming out.

The third buffer member 2521 may be disposed on the second extension part 2520. The third buffer member 2521 may be disposed on an upper region of the second extension part 2520. The third buffer member 2521 may be disposed in the third hole 2113 of the second housing 2100. For example, the third buffer member 2521 may be disposed between the third protrusion 2113a and the fourth protrusion 2113b of the third hole 2113. The third buffer member 2521 may be fixed to a position set by the third protrusion 2113a and the fourth protrusion 2113b. In addition, the third buffer member 2521 may include a through hole into which the second extension part 2520 is inserted.

The fourth buffer member 2522 may be disposed on the second extension part 2520. The fourth buffer member 2522 may be disposed on a lower region of the second extension part 2520. The fourth buffer member 2522 may be spaced apart from the third buffer member 2521 in the optical axis direction. The fourth buffer member 2522 may be disposed in a fifth hole (not shown) of the second housing 2100. The fourth buffer member 2522 may be disposed to be inserted into the fifth hole. The second buffer member 2322 may include a through hole into which the second extension part 2520 is inserted.

The third buffer member 2521 and the fourth buffer member 2522 may prevent noise caused by vibration of the second extension part 2520. In addition, the third buffer member 2521 and the fourth buffer member 2522 may prevent the second extension part 2520 from being deformed or damaged by an external impact.

The second camera actuator 2000 may include a first magnetic scaler 2610, a first sensing unit (not shown), a second magnetic scaler 2620, and a second sensing unit (not shown).

The first magnetic scaler 2610 may be disposed on the first lens barrel 2200. For example, the first magnetic scaler 2610 may be disposed on the first lower surface 2223. In detail, the first magnetic scaler 2610 may be disposed in the first groove 223h1 of the first lens barrel 2200. The first magnetic scaler 2610 may move along the optical axis direction together with the first lens barrel 2200.

The first magnetic scaler 2610 may include a plurality of magnets. For example, the first magnetic scaler 2610 may have an N pole and an S pole alternately disposed in the optical axis direction.

The first sensing unit may be disposed adjacent to the first magnetic scaler 2610. For example, the first sensing unit may be disposed to face the first magnetic scaler 2610 in a first direction (x-axis direction) or a second direction (y-axis direction). The first sensing unit may detect a position of the first magnetic scaler 2610. Through this, the first sensing unit may detect the position and movement of the first lens barrel 2200 moving together with the first magnetic scaler 2610.

The second magnetic scaler 2620 may be disposed on the second lens barrel 2400. For example, the second magnetic scaler 2620 may be disposed on the second upper surface 2423. In detail, the second magnetic scaler 2620 may be disposed in the third groove 2423h1 of the second lens barrel 2400. The second magnetic scaler 2620 may move along the optical axis direction together with the second lens barrel 2400.

The second magnetic scaler 2620 may include a plurality of magnets. For example, the second magnetic scaler 2620 may have an N pole and an S pole alternately disposed in the optical axis direction.

Also, the second sensing unit may be disposed adjacent to the second magnetic scaler 2620. For example, the second sensing unit may be disposed to face the second magnetic scaler 2620 in a first direction (x-axis direction) or a second direction (y-axis direction). The second sensing unit may detect a position of the second magnetic scaler 2620. Through this, the second sensing unit may detect the position and movement of the second lens barrel 2400 moving together with the second magnetic scaler 2620.

Also, although not shown in the drawings, the second camera actuator 2000 according to the embodiment may further include a gyro sensor (not shown). The gyro sensor may be disposed in the second housing 2100. The gyro sensor may detect a movement of a user using the camera actuator.

The second camera actuator 2000 according to the embodiment may include a second substrate 2800. The second substrate 2800 may be disposed on the second housing 2100. The second substrate 2800 may be disposed to surround a partial region of the second housing 2100. For example, the second substrate 2800 may be disposed to surround a portion of the outer side of the second sub-housing 2120. The second substrate 2800 may provide power or current to components disposed in the second housing 2100. That is, the second substrate 2800 may be a circuit board, and may include a circuit board having a wiring pattern that can be electrically connected, such as a rigid printed circuit board (Rigid PCB), a flexible printed circuit board (Flexible PCB), and a rigid flexible printed circuit board (Rigid Flexible PCB). The second substrate 2800 may be electrically connected to the above-described first circuit board 310.

The second substrate 2800 may include a first end 2810. The first end 2810 may be disposed on the first piezoelectric device 2310 of the third driving unit 2300. For example, the first end 2810 may be disposed on the first disk part 2311 of the first piezoelectric device 2310. In detail, the first end 2810 may be disposed on one surface of the first disk part 2311. Also, the first end 2810 may be disposed on the second piezoelectric device 2510 of the fourth driving unit 2500. For example, the second end 2820 may be disposed on the second disk part 2511 of the second piezoelectric device 2510. In detail, the first end 2810 may be disposed on one surface of the second disk part 2511.

The second substrate 2800 may include a second end 2820. The first end 2810 may be spaced apart from the first end 2810. Also, the second end 2820 may be disposed in a region that does not overlap the first end 2810 in the optical axis direction.

The second end 2820 may be disposed on the first piezoelectric device 2310 of the third driving unit 2300. For example, the second end 2820 may be disposed on the first disk part 2311 of the first piezoelectric device 2310. In detail, the first end 2810 may be disposed on the other surface opposite to one surface of the first disk part 2311. Also, the second end 2820 may be disposed on the second piezoelectric device 2510 of the fourth driving unit 2500. For example, the second end 2820 may be disposed on the second disk part 2511 of the second piezoelectric device 2510. In detail, the second end 2820 may be disposed on the other surface opposite to one surface of the second disk part 2511.

That is, the second substrate 2800 may supply power to the first piezoelectric device 2310 and the second piezoelectric device 2510. Accordingly, the third driving unit 2300 and the fourth driving unit 2500 may drive the first lens barrel 2200 and the second lens barrel 2400 by the applied power, respectively.

As described above, the second camera actuator 2000 according to the embodiment includes a third driving unit 2300 and a fourth driving unit 2500 including a piezoelectric device, and the first and second lens barrels 2200 and 2400 may be moved in the optical axis direction by the third and fourth driving units 2300 and 2500. However, the embodiment is not limited thereto, and the third and fourth driving units 2300 and 2500 may include a voice coli motor (VCM) or a shape memory alloy. In this case, the third and fourth driving units 2300 and 2500 may move the first and second lens barrels 2200 and 2400 by using the electromagnetic force of the VCM or a physical change of the shape memory alloy.

The second camera actuator 2000 according to the embodiment may include an image sensor 2900. The image sensor 2900 may collect light passing in the order of the first lens unit 2105, the second lens unit 2205, and the third lens unit 2405 and convert it into an image. The image sensor 2900 may be disposed to coincide with an optical axis of a lens of the lens units 105, 205, and 405. The optical axis of the image sensor 2900 and the optical axis of the lens may be aligned.

FIG. 21 is a perspective view of a mobile terminal to which a camera module according to an embodiment is applied.

Referring to FIG. 21, the mobile terminal 3 may include a camera module 10, an autofocus device 31, and a flash module 33 provided on the rear side.

The camera module 10 may include an image capturing function and an auto focus function. For example, the camera module 10 may include an auto-focus function using an image.

The camera module 10 processes an image frame of a still image or a moving image obtained by an image sensor in a shooting mode or a video call mode. The processed image frame may be displayed on a predetermined display unit and stored in a memory. A camera (not shown) may also be disposed on the front of the mobile terminal body.

For example, the camera module 10 may include a first camera module 10A and a second camera module 10B. In this case, at least one of the first camera module 10A and the second camera module 10B may include the aforementioned camera module, for example, the camera module 10 according to FIGS. 1 to 20. Accordingly, the camera module 10 may implement an OIS function together with a zoom function and an autofocus function.

The auto focus device 31 may include an auto focus function using a laser. The auto focus device 31 may be mainly used in a condition in which the auto focus function using the image of the camera module 10 is deteriorated, for example, in proximity of 10 m or less or in a dark environment. The autofocus device 31 may include a light emitting unit including a vertical cavity surface emitting laser (VCSEL) semiconductor device and a light receiving unit that converts light energy such as a photodiode into electrical energy.

The flash module 33 may include a light emitting device emitting light therein. The flash module 33 may be operated by a camera operation of a mobile terminal or by a user’s control.

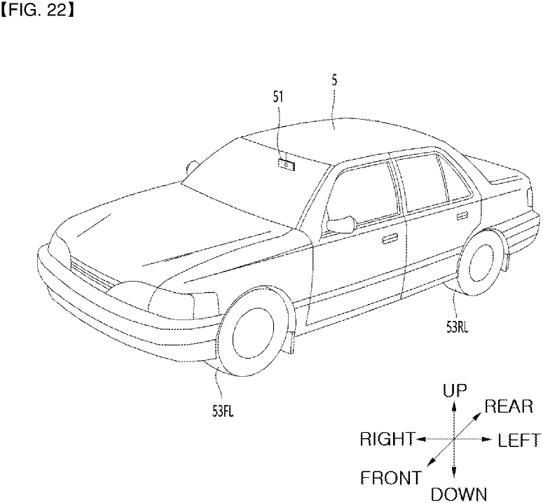

Next, FIG. 22 is a perspective view of the vehicle 5 to which the camera module according to the embodiment is applied. For example, FIG. 22 is an external view of a vehicle including a vehicle driving assistance device to which the camera module 10 according to the embodiment is applied.

Referring to FIG. 22, the vehicle 5 according to the embodiment may include wheels 53FL and 53RL that rotate by a power source and a predetermined sensor. The sensor may be the camera sensor 51, but is not limited thereto.

The camera 51 may be a camera sensor to which the camera module according to the embodiment, for example, the camera module 10 according to FIGS. 1 to 20 is applied.

The vehicle 5 of the embodiment may acquire image information through a camera sensor 51 that captures a front image or a surrounding image, and it is possible to determine a lane non-identification situation using the image information, and generate a virtual lane when the lane is not identified.

For example, the camera sensor 51 may acquire a front image by photographing the front of the vehicle 5, and a processor (not shown) may obtain image information by analyzing an object included in the front image.

For example, when an object such as a median, curb, or street tree corresponding to a lane, an adjacent vehicle, a driving obstacle, and an indirect road marking is captured in the image captured by the camera sensor 51, the processor may detect such an object and include it in the image information.

In this case, the processor may further supplement the image information by acquiring distance information from the object detected through the camera sensor 51. The image information may be information about an object photographed in an image.

The camera sensor 51 may include an image sensor and an image processing module. The camera sensor 51 may process a still image or a moving image obtained by an image sensor (eg, CMOS or CCD). The image processing module may process a still image or a moving image obtained through the image sensor, extract necessary information, and transmit the extracted information to the processor.

In this case, the camera sensor 51 may include a stereo camera to improve the measurement accuracy of the object and further secure information such as the distance between the vehicle 5 and the object, but is not limited thereto.

Features, structures, effects, etc. described in the above embodiments are included in at least one embodiment, and it is not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and variations should be interpreted as being included in the scope of the embodiments.

In the above, the embodiment has been mainly described, but this is only an example and does not limit the embodiment, and those of ordinary skill in the art to which the embodiment pertains will appreciate that various modifications and applications not illustrated above are possible without departing from the essential characteristics of the present embodiment. For example, each component specifically shown in the embodiment can be implemented by modification. And the differences related to these modifications and applications should be interpreted as being included in the scope of the embodiments set forth in the appended claims.

1. A camera actuator comprising:
a housing;
a prism unit disposed in the housing; and
a first driving unit for the prism unit;
wherein the prism unit includes:
a prism; and
a prism mover disposed to surround the prism, and
a second driving unit disposed between the prism and the prism mover and driving the prism, and
wherein a driving displacement of the second driving unit is smaller than a driving displacement of the first driving unit.

2. The camera actuator of claim 1, wherein the second driving unit includes a plurality of piezoelectric devices,
wherein the prism mover includes an inner surface facing one side surface of the prism and inclined at a predetermined angle, and
wherein the plurality of piezoelectric devices is disposed on the inner surface of the prism mover.

3. The camera actuator of claim 2, wherein the first driving unit includes a plurality of sub driving units including a coil unit and a magnet,
wherein the plurality of sub driving units includes:
a first sub driving unit facing a first outer surface of the prism mover;
a second sub driving unit facing a second outer surface of the prism mover; and
a third sub driving unit facing a lower surface of the prism mover,
wherein the first and second sub driving units face each other in a first direction, and
wherein the third sub driving unit faces the prism unit in a second direction perpendicular to the first direction.

4. The camera actuator of claim 3, wherein the first driving unit is provided to rotate the prism unit in the second direction with a virtual first line formed by the first and second sub driving units in the first direction as an axis.

5. The camera actuator of claim 3, wherein the first driving unit is provided to rotate the prism unit in the first direction with a virtual second line formed by the third and fourth sub driving units in the second direction as an axis.

6. The camera actuator of claim 3, wherein the plurality of piezoelectric devices includes:
first and second piezoelectric devices spaced apart from each other in the second direction; and
third and fourth piezoelectric devices spaced apart from each other in the first direction.

7. The camera actuator of claim 6, wherein the prism is provided to be rotationally movable in the second direction by at least one of the first and second piezoelectric devices on the prism mover.

8. The camera actuator of claim 6, wherein the prism is provided to be rotatably movable in the first direction by at least one of the third and fourth piezoelectric devices on the prism mover.

9. The camera actuator of claim 2, wherein the second driving unit includes:
a circuit board disposed on the inner surface of the prism mover; and
a base layer disposed on the circuit board and including a plurality of openings,
wherein the plurality of piezoelectric devices are respectively disposed in the plurality of openings.

10. The camera actuator of claim 9, wherein the base layer includes an elastically deformable material.

11. The camera actuator of claim 1, wherein the first driving unit drives the prism unit in a first driving method, amd
wherein the second driving unit drives the prism in a second driving method different from the first driving method.

12. The camera actuator of claim 9, wherein a thickness of each of the plurality of piezoelectric devices is greater than or equal to a thickness of the base layer.

13. A camera module comprising:
a first camera actuator, and
a second camera actuator,
wherein the first camera actuator performs an OIS (Optical Image Stabilizer) function,
wherein the second camera actuator performs an auto focusing or zoom function,
wherein light incident from an outside is incident on the second camera actuator through the first camera actuator,
wherein the first camera actuator includes:
a housing;
a prism unit disposed in the housing; and
a first driving unit for driving the prism unit;
wherein the prism unit includes:
a prism; and
a prism mover disposed to surround the prism, and
a second driving unit disposed between the prism and the prism mover and driving the prism, and
wherein a driving displacement of the second driving unit is smaller than a driving displacement of the first driving unit.

14. The camera module of claim 13, wherein the second driving unit includes a plurality of piezoelectric devices,
wherein the prism mover includes an inner surface facing one side surface of the prism and inclined at a predetermined angle, and
wherein the plurality of piezoelectric devices is disposed on the inner surface of the prism mover.

15. The camera module of claim 14, wherein the first driving unit includes a plurality of sub driving units including a coil unit and a magnet,
wherein the plurality of sub driving units includes:
a first sub driving unit facing a first outer surface of the prism mover;
a second sub driving unit facing a second outer surface of the prism mover; and
a third sub driving unit facing a lower surface of the prism mover,
wherein the first and second sub driving units face each other in a first direction, and
wherein the third sub driving unit faces the prism unit in a second direction perpendicular to the first direction.

16. The camera module of claim 15, wherein the first driving unit is provided to rotate the prism unit in the second direction with a virtual first line formed by the first and second sub driving units in the first direction as an axis.

17. The camera module of claim 15, wherein the first driving unit is provided to rotate the prism unit in the first direction with a virtual second line formed by the third and fourth sub driving units in the second direction as an axis.

18. The camera module of claim 15, wherein the plurality of piezoelectric devices includes:
first and second piezoelectric devices spaced apart from each other in the second direction; and
third and fourth piezoelectric devices spaced apart from each other in the first direction, and
wherein the prism is provided to be rotationally movable in the second direction by at least one of the first and second piezoelectric devices on the prism mover.

19. The camera module of claim 17, wherein the prism is provided to be rotatably movable in the first direction by at least one of the third and fourth piezoelectric devices on the prism mover.

20. The camera module of claim 14, wherein the second driving unit includes:
a circuit board disposed on the inner surface of the prism mover; and
a base layer disposed on the circuit board and including a plurality of openings,
wherein the plurality of piezoelectric devices are respectively disposed in the plurality of openings.
